(19) United States
(12) Patent Application Publication
(10) Pub. No.: US 2026/0370300 A1
(43) Pub. Date: Nov. 19, 2026

(54) 60 GIGAHERTZ (GHZ) BEAM TRAINING DESIGNS FOR INTEGRATED MILLIMETER WAVE (IMMW) WI-FI NETWORKS

(71) Applicant: QUALCOMM Incorporated, San Diego, CA (US)

(72) Inventors: Lin YANG, San Diego, CA (US); Bin TIAN, San Diego, CA (US); Alecsander Petru EITAN, Haifa (IL); Tzu-Hsuan CHOU, San Diego, CA (US); Youhan KIM, Saratoga, CA (US)

(21) Appl. No.: 19/649,113

(22) Filed: Apr. 16, 2026

Related U.S. Application Data
(60) Provisional application No. 63/807,300, filed on May 16, 2025.

(51) Int. Cl. H04B 7/06

(52) U.S. Cl. CPC H04B 7/06952

(57) ABSTRACT

This disclosure provides methods, components, devices and systems that support beam training sequences via a 60 gigahertz (GHz) link, with or without assistance from a sub-7 GHz link. The beam training sequences may include one or multiple stages. A first stage may involve a transmission of a respective set of null data packet (NDP) physical layer protocol data units (PPDUs) via the 60 GHz link by each of two communication devices, each NDP PPDU transmitted using a respective transmit beam. A second stage may involve a transmission of a respective PPDU via the 60 GHz link by each of the two communication devices, each PPDU including multiple training (TRN) subfields transmitted using a same transmit beam or multiple different transmit beams depending on a beam training direction of that PPDU.

### PRIORITY INFORMATION

This Patent Application claims the benefit of U.S. Provisional Patent Application No. 63/807,300 by YANG et al., entitled “60 GIGAHERTZ (GHZ) BEAM TRAINING DESIGNS FOR INTEGRATED MILLIMETER WAVE (IMMW) WI-FI NETWORKS,” filed May 16, 2025, assigned to the assignee hereof, and expressly incorporated herein.

### TECHNICAL FIELD

This disclosure relates generally to wireless communication and, more specifically, to 60 gigahertz (GHz) beam training designs for integrated millimeter wave (IMMW) Wi-Fi networks.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first communication device. The first communication device may include a processing system that includes processor circuitry and memory circuitry that stores code. The processing system may be configured to cause the first communication device to transmit, via a sub-7 gigahertz (GHz) link, a first action frame that indicates a first set of beam training parameters and a first timing and frequency reference for at least a first phase of a beam training sequence between the first communication device and a second communication device via a 60 GHz link, transmit, via the 60 GHz link, a set of multiple first beam training packets in accordance with the first set of beam training parameters and the first timing and frequency reference, where each first beam training packet of the set of multiple first beam training packets is transmitted using a respective first transmit beam of a set of multiple first transmit beams at the first communication device, and receive, from the second communication device and via the sub-7 GHz link or the 60 GHz link, feedback on at least one first transmit beam of the set of multiple first transmit beams.

Another innovative aspect of the subject matter described in this disclosure can be implemented in a method for wireless communication by or at a first communication device. The method may include transmitting, via a sub-7 GHz link, a first action frame that indicates a first set of beam training parameters and a first timing and frequency reference for at least a first phase of a beam training sequence between the first communication device and a second communication device via a 60 GHz link, transmitting, via the 60 GHz link, a set of multiple first beam training packets in accordance with the first set of beam training parameters and the first timing and frequency reference, where each first beam training packet of the set of multiple first beam training packets is transmitted using a respective first transmit beam of a set of multiple first transmit beams at the first communication device, and receiving, from the second communication device and via the sub-7 GHz link or the 60 GHz link, feedback on at least one first transmit beam of the set of multiple first transmit beams.

Some implementations of the methods and first communication device described herein may further include operations, features, means, or instructions for monitoring the 60 GHz link for a set of multiple second beam training packets from the second communication device, where each second beam training packet of the set of multiple second beam training packets corresponds to a respective second transmit beam of a set of multiple second transmit beams at the second communication device.

In some implementations of the methods and first communication device described herein, the set of multiple second beam training packets from the second communication device may be in accordance with the first set of beam training parameters indicated by the first action frame.

Some implementations of the methods and first communication devices described herein may further include operations, features, means, or instructions for transmitting, to the second communication device and via the sub-7 GHz link, a second action frame that indicates a second set of beam training parameters and a second timing and frequency reference for a second phase of the beam training sequence between the first communication device and the second communication device, where the set of multiple second beam training packets from the second communication device may be in accordance with the second set of beam training parameters and the second timing and frequency reference indicated by the second action frame.

Some implementations of the methods and first communication devices described herein may further include operations, features, means, or instructions for receiving, from the second communication device and via the sub-7 GHz link, a second action frame that indicates second set of beam training parameters and a second timing and frequency reference for a second phase of the beam training sequence between the first communication device and the second communication device, where the set of multiple second beam training packets from the second communication device may be in accordance with the second set of beam training parameters and the second timing and frequency reference indicated by the second action frame.

Another innovative aspect of the subject matter described in this disclosure can be implemented in a first communication device. The first communication device may include a processing system that includes processor circuitry and memory circuitry that stores code. The processing system may be configured to cause the first communication device to transmit, via a 60 GHz link, a set of multiple first beam training packets in accordance with a beam training sequence of a beam recovery procedure between the first communication device and a second communication device on the 60 GHz link, where each first beam training packet of the set of multiple first beam training packets is transmitted using a respective first transmit beam of a set of multiple first transmit beams at the first communication device, in accordance with a first set of beam training parameters, and receive, from the second communication device and via the 60 GHz link, feedback on at least one first transmit beam of the set of multiple first transmit beams.

Another innovative aspect of the subject matter described in this disclosure can be implemented in a method for wireless communication by or at a first communication device. The method may include transmitting, via a 60 GHz link, a set of multiple first beam training packets in accordance with a beam training sequence of a beam recovery procedure between the first communication device and a second communication device on the 60 GHz link, where each first beam training packet of the set of multiple first beam training packets is transmitted using a respective first transmit beam of a set of multiple first transmit beams at the first communication device, in accordance with a first set of beam training parameters, and receiving, from the second communication device and via the 60 GHz link, feedback on at least one first transmit beam of the set of multiple first transmit beams.

Some implementations of the methods and first communication devices described herein may further include operations, features, means, or instructions for transmitting, via the 60 GHz link, an action frame that indicates the first set of beam training parameters, where transmission of the set of multiple first beam training packets may be in accordance with the action frame.

In some implementations of the methods and first communication devices described herein, each first beam training packet of the set of multiple first beam training packets includes an integrated millimeter wave (IMMW) signal (IMMW-SIG) field that indicates a respective subset of the first set of beam training parameters according to which that first beam training packet may be transmitted.

In some implementations of the methods and first communication devices described herein, the beam training sequence includes a sector level sweep (SLS) stage and a beam refinement protocol (BRP) stage and the SLS stage includes an exchange of a respective set of multiple beam training packets between the first communication device and the second communication device exclusively via the 60 GHz link in accordance with the beam recovery procedure on the 60 GHz link.

In some implementations of the methods and first communication devices described herein, the SLS stage includes at least one PPDU that includes an action frame, a trigger frame, or beamforming feedback and the at least one PPDU may have an extended long range (ELR) PPDU format in accordance with the SLS stage being exclusively via the 60 GHz link.

Another innovative aspect of the subject matter described in this disclosure can be implemented in a first communication device. The first communication device may include a processing system that includes processor circuitry and memory circuitry that stores code. The processing system may be configured to cause the first communication device to transmit, via a 60 GHz link, a first PPDU that includes a set of multiple first training (TRN) subfields in accordance with a beam training sequence between the first communication device and a second communication device, where the set of multiple first TRN subfields is transmitted using a single first transmit beam or a set of multiple first transmit beams at the first communication device in accordance with a first beam training direction, and receive, via the 60 GHz link, a second PPDU that includes a set of multiple second TRN subfields in accordance with the beam training sequence between the first communication device and the second communication device, where the set of multiple second TRN subfields is received using a single first receive beam or a set of multiple first receive beams at the first communication device in accordance with a second beam training direction.

Another innovative aspect of the subject matter described in this disclosure can be implemented in a method for wireless communication by or at a first communication device. The method may include transmitting, via a 60 GHz link, a first PPDU that includes a set of multiple first TRN subfields in accordance with a beam training sequence between the first communication device and a second communication device, where the set of multiple first TRN subfields is transmitted using a single first transmit beam or a set of multiple first transmit beams at the first communication device in accordance with a first beam training direction, and receiving, via the 60 GHz link, a second PPDU that includes a set of multiple second TRN subfields in accordance with the beam training sequence between the first communication device and the second communication device, where the set of multiple second TRN subfields is received using a single first receive beam or a set of multiple first receive beams at the first communication device in accordance with a second beam training direction.

In some implementations of the methods and first communication devices described herein, the first beam training direction includes at least one of a transmit beam training direction from the first communication device or a receive beam training direction at the second communication device. In some implementations of the method and first communication devices described herein, the second beam training direction includes at least one of a transmit beam training direction from the second communication device or a receive beam training direction at the first communication device.

In some implementations of the methods and first communication devices described herein, the first PPDU may be an NDP PPDU. In some implementations of the method and first communication devices described herein, the first PPDU may be a data PPDU.

Another innovative aspect of the subject matter described in this disclosure can be implemented in a communication device. The communication device may include a processing system that includes processor circuitry and memory circuitry that stores code. The processing system may be configured to cause the communication device to transmit, as part of a coarse beam search stage of a two-stage beam search operation, a first set of PPDUs via a subset of a set of multiple antenna elements at the communication device, where a transmission of each PPDU of the first set of PPDUs is in accordance with an application of a respective antenna weight vector (AWV) of a set of AWVs to the subset of the set of multiple antenna elements, and where each AWV of the set of AWVs corresponds to a respective coarse beam of a set of coarse beams in accordance with the application of the respective AWV to the subset of the set of multiple antenna elements, receive feedback that indicates a first coarse beam, of the set of coarse beams, in accordance with transmitting the first set of PPDUs, where the first coarse beam corresponds to a first AWV of the set of AWVs, and transmit, as part of a fine beam search stage of the two-stage beam search operation, a second set of PPDUs via the set of multiple antenna elements at the communication device and in accordance with applying the first AWV to the subset of the set of multiple antenna elements.

Another innovative aspect of the subject matter described in this disclosure can be implemented in a method for wireless communication by a communication device. The method may include transmitting, as part of a coarse beam search stage of a two-stage beam search operation, a first set of PPDUs via a subset of a set of multiple antenna elements at the communication device, where a transmission of each PPDU of the first set of PPDUs is in accordance with an application of a respective AWV of a set of AWVs to the subset of the set of multiple antenna elements, and where each AWV of the set of AWVs corresponds to a respective coarse beam of a set of coarse beams in accordance with the application of the respective AWV to the subset of the set of multiple antenna elements, receiving feedback that indicates a first coarse beam, of the set of coarse beams, in accordance with transmitting the first set of PPDUs, where the first coarse beam corresponds to a first AWV of the set of AWVs, and transmitting, as part of a fine beam search stage of the two-stage beam search operation, a second set of PPDUs via the set of multiple antenna elements at the communication device and in accordance with applying the first AWV to the subset of the set of multiple antenna elements.

Some implementations of the methods and communication devices described herein may further include operations, features, means, or instructions for transmitting the second set of PPDUs may be further in accordance with applying one or more other AWVs to a remainder of the set of multiple antenna elements other than the subset of the set of multiple antenna elements.

In some implementations of the methods and communication devices described herein, applying each AWV of the one or more other AWVs to the remainder of the set of multiple antenna elements other than the subset of the set of multiple antenna elements forms a respective fine beam within the first coarse beam.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example signaling diagram that supports 60 gigahertz (GHz) beam training designs for integrated millimeter wave (IMMW) Wi-Fi networks.

FIG. 3-10 show example beam training sequences that support 60 GHz beam training designs for IMMW Wi-Fi networks.

FIG. 11 shows example null data packet (NDP) physical layer protocol data unit (PPDU) formats for a sector level sweep (SLS) stage of a beam training sequence that support 60 GHz beam training designs for IMMW Wi-Fi networks.

FIG. 12-14 show example PPDU formats for a beam refinement protocol (BRP) stage of a beam training sequence that support 60 GHz beam training designs for IMMW Wi-Fi networks.

FIG. 15-18 show example training (TRN) field structures that support 60 GHz beam training designs for IMMW Wi-Fi networks.

FIG. 19 shows an example two-stage beam search operation that supports 60 GHz beam training designs for IMMW Wi-Fi networks.

FIG. 20 shows a block diagram of an example wireless communication device that supports 60 GHz beam training designs for IMMW Wi-Fi networks.

FIG. 21-24 show flowcharts illustrating example processes performable by or at a communication device that supports 60 GHz beam training designs for IMMW Wi-Fi networks.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group, or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks support communication via a 60 gigahertz (GHz) link, which may enable high data rate wireless connectivity between access points (APs) and stations (STAs) due to the relatively larger amount of available bandwidth at 60 GHz (as compared to other, lower frequency bands). Such networks may additionally support one or more sub-7 GHz links (such as a 2.4 GHz link, a 5 GHz link, or a 6 GHz link) in multi-band configurations, enabling communication devices to maintain connectivity via a relatively lower frequency band in addition to using the 60 GHz link for high data rate communications. Communication devices within such networks may therefore communicate via a relatively lower frequency link (such as a sub-7 GHz link), a relatively higher frequency link (such as a 60 GHz link), or both. In some deployment scenarios, wireless communication via the 60 GHz link may experience link budget constraints due to increased path loss and poor penetration through obstacles. To overcome such propagation challenges, communication devices may employ beamforming techniques that focus transmission energy in one or more specific directions. Such beamforming techniques may involve beamforming training protocols according to which communication devices may determine (such as measure, calculate, derive, select, identify, or otherwise ascertain) suitable transmit and receive beams to use for communicating via the 60 GHz link. Some beamforming training protocols, however, incur high overhead costs, which may become increasingly problematic in dynamic environments with frequent re-training. Further, some beamforming training protocols are not designed to fully leverage multi-link operation (MLO) capabilities, which may limit the attainable efficiency of beam training. Thus, some networks may benefit from more efficient beam training sequences, including beam training sequences that leverage MLO capabilities for more efficient packet formatting.

Various aspects relate generally to 60 GHz beam training designs for integrated millimeter wave (IMMW) Wi-Fi networks, such as Wi-Fi networks that support communication via a 60 GHz link. Some aspects more specifically relate to beam training sequences via the 60 GHz link, with or without assistance from a sub-7 GHz link, and to packet formats for the beam training sequences. The beam training sequences may include a sector level sweep (SLS) stage, a beam refinement protocol (BRP) stage, or both. In some implementations, the SLS stage may correspond to a coarse beam search stage of a beam training sequence and the BRP stage may correspond to a fine beam search stage of the beam training sequence. For example, a communication device may transmit or receive using relatively coarser (such as wider) beams within the SLS stage of the beam training sequence and may transmit or receive using relatively finer (such as narrower) beams within the BRP stage of the beam training sequence.

The SLS stage may involve a transmission, by a first communication device within a first (initiator) phase of the SLS stage, of a set of first beam training packets (such as null data packet (NDP) physical layer protocol data units (PPDUs)) via the 60 GHz link and a transmission, by a second communication device within a second (responder) phase of the SLS stage, of a set of second beam training packets (such as NDP PPDUs) via the 60 GHz link. The first communication device may transmit each beam training packet of the first beam training packets using a respective transmit beam at the first communication device and the second communication device may transmit each beam training packet of the second beam training packets using a respective transmit beam at the second wireless communication device. The BRP stage may involve a transmission, by the first communication device, of a first PPDU and a transmission, by the second communication device, of a second PPDU. Each of the first PPDU and the second PPDU may include multiple training (TRN) subfields transmitted using a same transmit beam or multiple different transmit beams depending on a beam training direction of that PPDU. For example, a structure of TRN subfields within a BRP PPDU (a PPDU transmitted as part of the BRP stage) may depend on the beam training direction of the BRP PPDU. The PPDUs of the BRP stage may be NDP PPDUs or data PPDUs.

In some aspects, the first communication device and the second communication device may participate in a beam training sequence in accordance with a set of beam training parameters. In some implementations, an initiator of the beam training sequence may indicate a single set of beam training parameters for both phases (the initiator phase and the responder phase) of the SLS stage. In some other implementations, the initiator of the beam training sequence may indicate a first set of beam training parameters for the first (initiator) phase of the SLS stage and the initiator or a responder of the beam training sequence may indicate a second set of beam training parameters for the second (responder) phase of the SLS stage. Such beam training parameters may be indicated via the sub- 7 GHz link or the 60 GHz link and, in some implementations, may include beam training parameters for the BRP stage. In some aspects, a format of the beam training packets (which may be NDP PPDUs) transmitted as part of the SLS stage or a format of the PPDUs transmitted as part of the BRP stage, or both, may depend on whether the beam training parameters are indicated via the sub- 7 GHz link or the 60 GHz link.

Particular aspects of the subject matter described in this disclosure can be implemented to realize one or more of the following potential advantages. In some examples, by supporting beam training sequences via the 60 GHz link with and without assistance from the sub-7 GHz link, communication devices using the beam training sequences may experience faster and more reliable beam searches and more accurately determine suitable transmit and receive beams to use for communication via the 60 GHz link across various deployment scenarios. Further, by using assistance from the sub- 7 GHz link for beam training via the 60 GHz link, the communication devices may further support a reliability of the beam training sequence by using the sub-7 GHz link for indicating beam training parameters and using the 60 GHz link for beamformed physical layer transmissions. Moreover, by supporting different PPDU formats for one or both of the SLS stage and the BRP stage in accordance with whether assistance is provided via the sub-7 GHz link, the communication devices may opportunistically reduce signaling overhead and reduce a latency incurred by the beam training sequence, which may facilitate greater spectral efficiency, higher data rates, lower complexity, and lower device power consumption along with enabling the communication devices to react more quickly in dynamic environments.

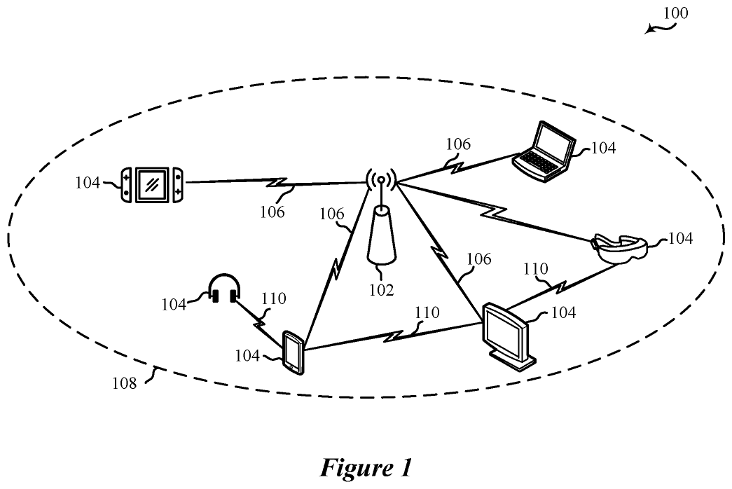

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq IMMW study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may select a single primary 20 MHz channel on which the AP 102 and the STAs 104 in its BSS monitor for contention-based access schemes. In some examples, the AP 102 or the STAs 104 may be capable of monitoring a single primary 20 MHz channel for packet detection (such as for detecting preambles of PPDUs). Any transmission by an AP 102 or a STA 104 within a BSS may involve transmission on the primary 20 MHz channel. As such, in some systems, the transmitting device may contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting legacy operation (such as only legacy operation) such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as the AP 102 and the STAs 104 in wireless communication network 100) may use IMMW techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, a universal signal field (U-SIG) of an ELR PPDU may include a first indication (such as a codepoint of a PHY version identifier subfield within a version-independent portion of the U-SIG or a value of an ELR subfield within a version-dependent portion of the U-SIG) that the PPDU is associated with (has) an ELR format. The U-SIG of an ELR PPDU may include a second indication (such as a STA identifier subfield within the version-dependent portion of the U-SIG) of an intended receiver of the PPDU. In some examples, an ELR PPDU may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, in some examples, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can listen to, and transmit or receive on, one communication link at any given time.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

Two or more communication devices of the wireless communication network 100 may support a beam search in one or more of various frequency bands, such as a 60 GHz frequency band. For example, the communication devices may each support a 60 GHz link (such as a communication link via which the communication devices communicate via a 60 GHz frequency band) and may support a beam search operation via the 60 GHz link. Beam search in 60 GHz may include an initial full beam search, a full or partial beam recovery in accordance with a link breaking (such as when a link is broken), beam refinement during data transmission, or any combination thereof.

An initial full beam search may include BSS discovery or association via a sub-7 GHz link (such as a 2.4 GHz link, a 5 GHz link, or a 6 GHz link) using MLO, with the initial beam search at the 60 GHz link being scheduled and configured by signaling communicated (such as transmitted or received) via the sub-7 GHz link. The initial full beam search at the 60 GHz link may include or involve a complete beam or sector search space. A full or partial beam recovery may include a beam recovery process, which may be initiated or assisted by signaling communicated via the sub-7 GHz link or via the 60 GHz link (such that the beam recovery process may be a standalone process via or on the 60 GHz link). A communication device may perform beam refinement during data transmission in a periodic manner (such as according to a defined or indicated periodicity) or in an on-demand manner (such as in accordance with or based on a link quality metric). The communication device may combine the beam refinement with a rate adaptation procedure. The communication device may perform the beam refinement via the 60 GHz link as a standalone process (such as without assisting signaling communicated via a sub-7 GHz link).

Beam search techniques may include one-dimensional (1D) beam searching or two-dimensional (2D) beam searching. In accordance with 2D beam searching, communication devices may scan over a set of (such as all) transmit (Tx) and receive (Rx) beams and obtain (such as receive, measure, calculate, derive, or otherwise acquire) a relatively higher beamforming gain. For one link direction, 2D beam searching may involve a relatively larger quantity of training packets, with such a quantity of training packets being equal to a product of a first quantity of transmit beams (which may be denoted as N_{sector,tx}) and a second quantity of receive beams (which may be denoted as N_{sector,rx}). Additionally, 2D beam searching may involve a relatively large training overhead due to a relatively larger amount of antenna elements used for communication via a 60 GHz frequency band. Further, in scenarios in which RF transmit and receive reciprocity does not hold, the overhead may be doubled for both downlink and uplink training. For 2D beam searching, on the transmit side, a communication device may repeatedly beamform a training signal to each of a set of transmit sectors. For receive-side beam sweeping, the transmitted beamformed training signals may be received successfully over at least one (and potentially each) receive beam, with a beam pair being selected in accordance with (such as based on) a complete set of performed measurements.

In accordance with 1D beam searching, communication devices may scan over either transmit or receive beams to reduce signaling overhead and obtain a relatively lower beamforming gain. For one link direction, 1D beam searching may involve a relatively smaller quantity of training packets, with such a quantity of training packets being equal to a summation of a first quantity of transmit beams (which may be denoted as N_{sector,tx}) and a second quantity of receive beams (which may be denoted as N_{sector,rx}). For example, an initiator (such as an AP 102) may transmit a set of training signals, each training signal transmitted in accordance with a respective transmit beam at the initiator. A responder (such as a STA 104) may monitor for the set of training signals using a single (omnidirectional, or approximately or quasi-omnidirectional) receive beam and perform one or more measurements on the set of training signals. The responder also may transmit a set of training signals, each training signal transmitted in accordance with a respective transmit beam at the responder. The initiator may monitor for the set of training signals using a single (omnidirectional, or approximately or quasi-omnidirectional) receive beam and perform one or more measurements on the set of training signals.

For 1D beam searching or 2D beam searching, the beam search operations may include an SLS stage and a BRP stage. The SLS stage may include beam training directions of Tx-SLS, Rx-SLS, or Tx/Rx-SLS. Tx-SLS may be equivalently referred to as “SLS-Tx,” Rx-SLS may be equivalently referred to as “SLS-Rx,” and Tx/Rx-SLS may be equivalently referred to as “Rx/Tx-SLS,” “SLS-Rx/Tx,” or “SLS-Tx/Rx.” The BRP stage may include beam training directions of BRP-Tx, BRP-Rx, or BRP-Rx/Tx. BRP-Tx may be equivalently referred to as “Tx-BRP,” BRP-Rx may be equivalently referred to herein as “Rx-BRP,” and BRP-Rx/Tx may be equivalently referred to herein as “BRP-Tx/Rx,” “Tx/Rx-BRP,” or “Rx/Tx-BRP.” In accordance with a Tx-SLS or a Tx/Rx-SLS beam training direction, a communication device may transmit SLS packets using two or more transmit beams at the communication device. In accordance with an Rx-SLS beam training direction, a communication device may transmit SLS packets using a single transmit beam at the communication device. In accordance with a BRP-Tx or a BRP-Rx/Tx beam training direction, a communication device may transmit a BRP packet using two or more transmit beams at the communication device. In accordance with an BRP-Rx beam training direction, a communication device may transmit a BRP packet using a single transmit beam at the communication device.

In some aspects, communication devices may use an SLS stage of a beam training sequence as part of an initial beam search and, in some scenarios, as part of a beam recovery procedure. For 1D beam searching (such as 1D scanning), one communication device may perform beam scanning over a set of candidate sectors and another communication device may be in a (quasi-)omnidirectional mode (in scenarios in which a communication direction is unknown) or in a fixed directional mode (in scenarios in which there is a known communication direction between the two communication devices). Such 1D beam scanning may be understood as a Tx-SLS or an Rx-SLS. For 2D beam searching (such as 2D beam scanning), an initiator may perform Tx-SLS repeatedly and a responder may receive in a directional mode and change a receive beam pattern once in each Tx-SLS period. Such 2D beam scanning may be understood as a Tx/Rx-SLS. In some systems, a communication device may perform an SLS by sending sector sweep (SSW) NDP PPDUs (which may be examples of SSW beam training packets) repeatedly and using a different transmit or receive beam for each SSW NDP PPDU (such as for each SSW beam training packet). In such systems, each NDP PPDU may be for testing one beam direction only, with no beam change within a PPDU. Between consecutive NDP PPDUs, there may be a time gap to allow sufficient time for a beam switch, which may be any duration including, for example, 1 microsecond or 18 microseconds.

Additionally, or alternatively, communication devices may use a BRP stage of a beam training sequence as part of a fine-tuning step (such as a fine beam search stage) after an initial transmit beam scanning or as part of an over-the-air (OTA) beam refinement while transmitting data. In some aspects, a communication device may perform BRP by including (and transmitting) a TRN field in an NDP or a data PPDU. In such aspects, the wireless communication device may communicate (such as transmit or receive) non-TRN fields in the PPDU with a strongest available or known Tx/Rx beam pair. The TRN field may be communicated with various beam directions for testing, depending on the training direction. For example, for BRP-Tx, communication devices may use a fixed receive beam direction (same receive direction as used for non-TRN fields) with a changing transmit beam direction in transmitting the TRN subfields. By way of further example, for BRP-Rx, communication devices may use a fixed transmit beam direction over repeated TRN subfields (same transmit direction as used for non-TRN fields) with a changing receive beam direction or a changing receive antenna element in each TRN subfield. By way of further example, for BRP-Tx/Rx, communication devices may cycle through a set of (such as all) combinations of candidate transmit beams (such as candidate transmit directions) and candidate receive beams (such as candidate receive directions).

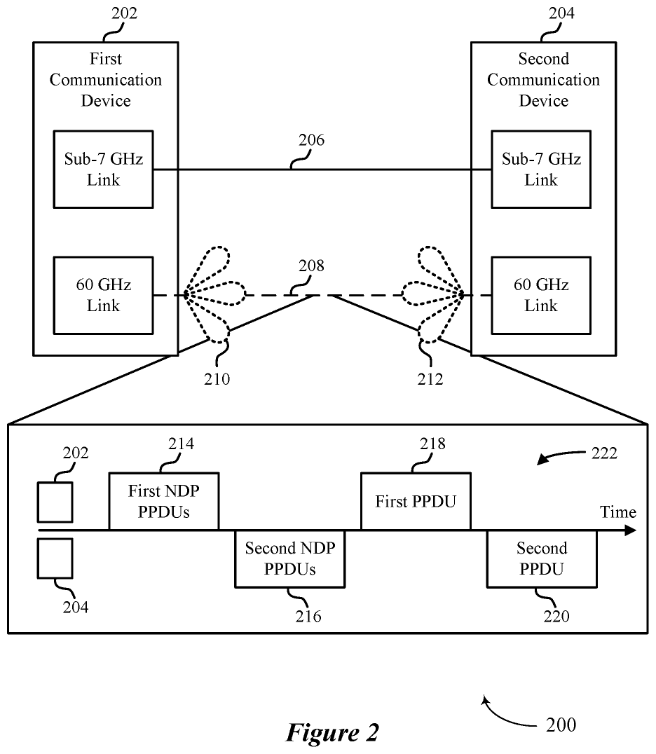

FIG. 2 shows an example signaling diagram 200 that supports 60 GHz beam training designs for IMMW Wi-Fi networks. The signaling diagram 200 may implement or be implemented to realize or facilitate one or more aspects of the wireless communication network 100. For example, the signaling diagram 200 illustrates communication between a first communication device 202 and a second communication device 204. The first communication device 202 may be an example of an AP 102 or a STA 104 as illustrated by and described with reference to FIG. 1. The second communication device 204 may be an example of an AP 102 or a STA 104 as illustrated by and described with reference to FIG. 1.

The first communication device 202 and the second communication device 204 may be examples of MLDs, each supporting (such as being configured to operate) one or more of multiple links. For example, each of the first communication device 202 and the second communication device 204 may support at least one sub-7 GHz link 206 and a 60 GHz link 208. The sub-7 GHz link 206 may be a 2.4 GHz link, a 5 GHz link, or a 6 GHz link. The 2.4 GHz link may be a link via which the first communication device 202 and the second communication device 204 communicate using a 2.4 GHz frequency band, which may span between 2.400 GHz-2.4835 GHz. The 5 GHz link may be a link via which the first communication device 202 and the second communication device 204 communicate using a 5 GHz frequency band, which may span between 5.15 GHz-5.85 GHz. The 6 GHz link may be a link via which the first communication device 202 and the second communication device 204 communicate using a 6 GHz frequency band, which may span between 5.925 GHz-7.125 GHz. Thus, communication via a “sub-7 GHz” link may sometimes exceed 7 GHz (up to 7.125 GHz), with “sub-7 GHz” generally referring to a frequency that is less than or equal to 7.125 GHz or to a defined frequency band that is at least partially less than or equal to 7 GHz. Further, reference to the 60 GHz link 208 is by way of example, and the first communication device 202 and the second communication device 204 may additionally, or alternatively, support one or more other links via which the first communication device 202 and the second communication device 204 communicate using a frequency band that is greater than 7 GHz (such as any frequency band between 7.125 GHz-300 GHz, among other examples).

In some aspects, the first communication device 202 and the second communication device 204 may perform directional communication, which may be referred to herein as beamforming, to reliably communicate via the 60 GHz link 208. For example, the first communication device 202 may use one or more beams 210 to transmit or receive communication from the second communication device 204 via the 60 GHz link 208. By way of further example, the second communication device 204 may use one or more beams 212 to transmit or receive communication from the first communication device 202 via the 60 GHz link 208. In some aspects, to select, ascertain, identify, derive, measure, calculate, or otherwise determine which one or more beams to use for communication via the 60 GHz link 208, the first communication device 202 and the second communication device 204 may perform (such as participate in) a beam training sequence 222 via the 60 GHz link 208.

The beam training sequence 222 may include one or multiple stages. For example, the beam training sequence 222 may include an SLS stage, a BRP stage, or both. The SLS stage of the beam training sequence 222 may include an exchange of a respective set of NDP PPDUs (which may be examples of beam training packets) between the first communication device 202 and the second communication device 204 via the 60 GHz link 208, such as the first NDP PPDUs 214 and the second NDP PPDUs 216. The first NDP PPDUs 214 may be an example of first beam training packets and the second NDP PPDUs 216 may be an example of second beam training packets. The BRP stage of the beam training sequence 222 may include an exchange of a respective PPDU (which may be a data PPDU or an NDP PPDU) between the first communication device 202 and the second communication device 204 via the 60 GHz link 208, such as the first PPDU 218 and the second PPDU 220.

The SLS stage and the BRP stage may each include multiple phases, such as an initiator phase and a responder phase. For example, the first NDP PPDUs 214 may be part of an initiator phase of the SLS stage and the second NDP PPDUs 216 may be part of a responder phase of the SLS stage. By way of further example, the first PPDU 218 may be part of an initiator phase of the BRP stage and the second PPDU 220 may be part of a responder phase of the BRP stage.

The first communication device 202 and the second communication device 204 may perform the beam training sequence 222 via the 60 GHz link 208 with or without assistance from signaling communicated via the sub-7 GHz link 206. In some implementations, for example, the first communication device 202 or the second communication device 204, or both, may transmit one or more frames or PPDUs via the sub-7 GHz link 206 to indicate one or more beam training parameters for one or more of the PPDUs of the beam training sequence 222, feedback on one or more beams used as part of the beam training sequence 222, or both. Additionally, or alternatively, the first communication device 202 or the second communication device 204, or both, may transmit one or more frames or PPDUs via the 60 GHz link 208 to indicate one or more beam training parameters for one or more of the PPDUs of the beam training sequence 222, feedback on one or more beams used as part of the beam training sequence 222, or both.

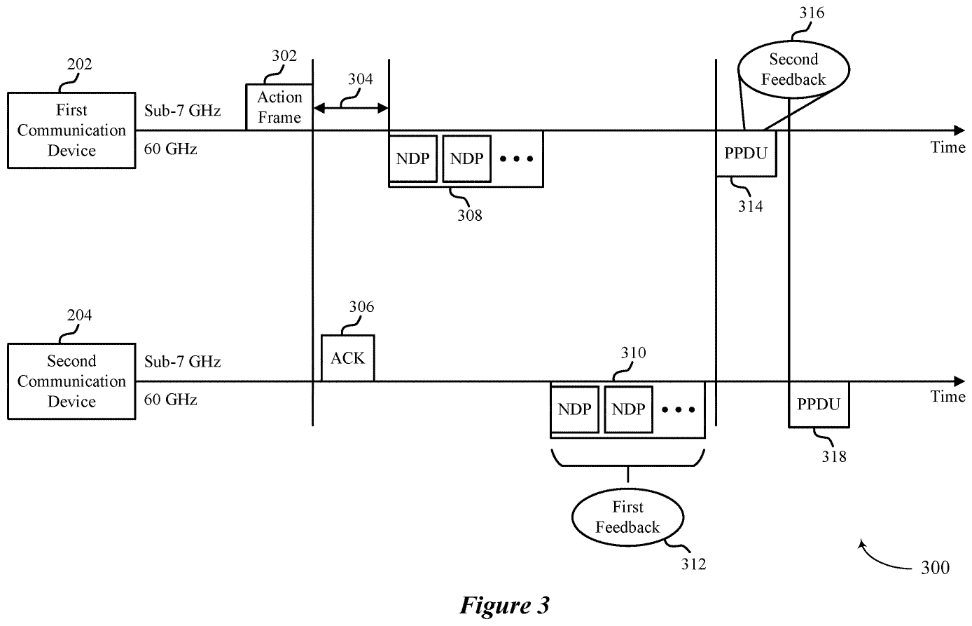

FIG. 3 shows an example beam training sequence 300 that supports 60 GHz beam training designs for IMMW Wi-Fi networks. The beam training sequence 300 (which may be equivalently referred to or understood as a sounding sequence) may implement or be implemented to realize or facilitate one or more aspects of the wireless communication network 100 or the signaling diagram 200. For example, the beam training sequence 300 may be an example of the beam training sequence 222 (with assistance from a sub-7 GHz link) between the first communication device 202 and the second communication device 204, as illustrated by and described with reference to FIG. 2. The first communication device 202 and the second communication device 204 may each support at least one sub-7 GHz link and a 60 GHz link, such as the sub-7 GHz link 206 and the 60 GHz link 208 as illustrated and described with reference to FIG. 2.

In some implementations, the first communication device 202 may transmit, via the sub-7 GHz link, an action frame 302. The action frame 302 may be a beamforming setup frame or an null data packet announcement (NDPA) frame, among other example action frames or other frame types. For example, the action frame 302 may be any frame that indicates information that pertains to the beam training sequence 300 via the 60 GHz link. The first communication device 202 may transmit the action frame 302 to setup (such as indicate or configure) one or more beam training parameters. Additionally, or alternatively, the first communication device 202 may transmit the action frame 302 to provide a timing and frequency reference for the 60 GHz link. For example, the action frame 302 may include an indication of a time delta 304 between the action frame 302 and an initial NDP PPDU (which may be an example of an initial beam training packet) sent via the 60 GHz link. In some implementations, the time delta 304 may be a default or fixed value, such as a value defined by a network specification or a value indicated from a set of possible values defined by a network specification. The second communication device 204 may transmit an ACK 306 in response to the action frame 302. In some implementations, the action frame 302 and the ACK 306 may be replaced by another message exchange sequence, such as a request message, a response message (responsive to the request message), and an NDPA or other action frame (subsequent to the response message).

In some aspects, the beam training sequence 300 illustrates a 1D beam scanning operation according to which the action frame 302 transmitted by the first communication device 202 via the sub-7 GHz link carries (such as indicates or provides) a complete set of beam training parameters for the beam training sequence 300 (such as all the beam training parameters throughout the full training procedure). In such aspects, the first communication device 202 may transmit a set of first NDP PPDUs 308 via the 60 GHz link in accordance with the beam training parameters indicated by the action frame 302 and the second communication device 204 may transmit a set of second NDP PPDUs 310 via the 60 GHz link in accordance with the beam training parameters indicated by the action frame 302. The set of first NDP PPDUs 308 may be an example of a set of first beam training packets and the set of second NDP PPDUs 310 may be an example of a set of second beam training packets. In accordance with the beam training parameters indicated by the action frame 302, the first communication device 202 may transmit each NDP PPDU of the first NDP PPDUs 308 via a respective first transmit beam of the first communication device 202 and the second communication device 204 may transmit each NDP PPDU of the second NDP PPDUs 310 via a respective second transmit beam of the second communication device 204.

The second communication device 204 may monitor for the first NDP PPDUs 308 via the 60 GHz link using a single receive beam (such as a quasi-omnidirectional receive beam) in accordance with the beam training parameters indicated by the action frame 302. The first communication device 202 may monitor for the second NDP PPDUs 310 via the 60 GHz link using a single receive beam (such as a quasi-omnidirectional receive beam) in accordance with the beam training parameters indicated by the action frame 302. In some implementations, at least one NDP PPDU of the second NDP PPDUs 310 may indicate first feedback 312 on at least one of the transmit beams used by the first communication device 202 to transmit the first NDP PPDUs 308. The first feedback 312 may include or indicate SLS/CSI feedback measured by the second communication device 204 using the first NDP PPDUs 308.

The first communication device 202 may transmit a first PPDU 314 in accordance with receiving the second NDP PPDUs 310 (and the first feedback 312). The first PPDU 314 may be an NDP PPDU or a data PPDU and may include multiple TRN subfields. The first communication device 202 may transmit sequences (multiple different sequences or a same sequence) via the multiple TRN subfields and may use a same transmit beam or different transmit beams in accordance with (such as depending on) a beam training direction. For example, a structure of the TRN subfields within the first PPDU 314 may be in accordance with the beam training direction. The first PPDU 314 may include second feedback 316 on at least one of the transmit beams used by the second communication device 204 to transmit the second NDP PPDUs 310. The second feedback 316 may include or indicate SLS/CSI feedback measured by the first communication device 202 using the second NDP PPDUs 310.

The second communication device 204 may receive the first PPDU 314 and transmit a second PPDU 318 in accordance with receiving the first PPDU 314. The second PPDU 318 may be an NDP PPDU or a data PPDU and may include multiple TRN subfields. The second communication device 204 may transmit sequences (multiple different sequences or a same sequence) via the multiple TRN subfields and may use a same transmit beam or different transmit beams in accordance with (such as depending on) a beam training direction. For example, a structure of the TRN subfields within the second PPDU 318 may be in accordance with the beam training direction.

In examples in which the beam training sequence 300 is partitioned into multiple stages, the first NDP PPDUs 308 and the second NDP PPDUs 310 may be part of an SLS stage of the beam training sequence 300 and the first PPDU 314 and the second PPDU 318 may be part of a BRP stage of the beam training sequence 300. Further, in examples in which the beam training sequence 300 is further partitioned into multiple phases, the first NDP PPDUs 308 may be part of an initiator Tx-SLS phase, the second NDP PPDUs 310 may be part of a responder Tx-SLS phase, the first PPDU 314 may be part of an initiator BRP-Rx phase, and the second PPDU 318 may be part of a responder BRP-Rx phase.

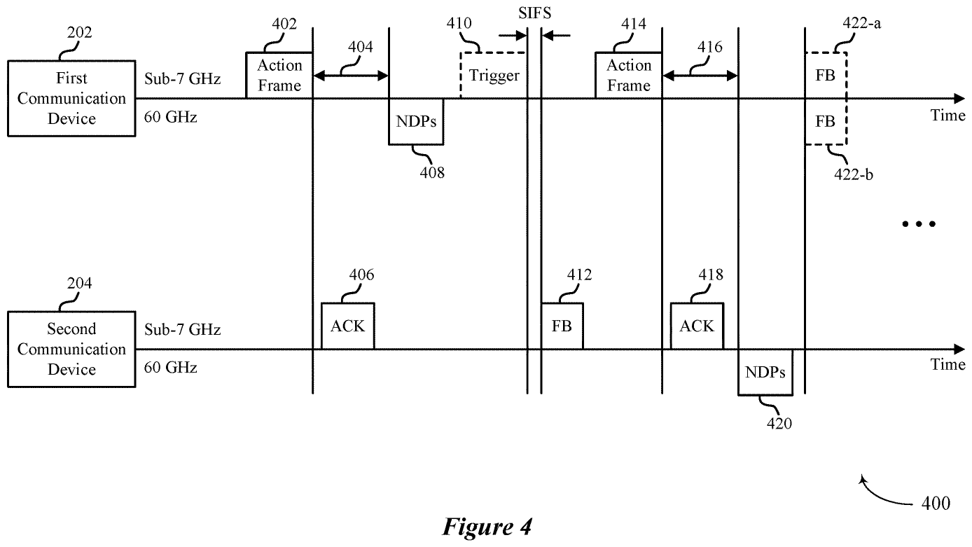

FIG. 4 shows an example beam training sequence 400 that supports 60 GHz beam training designs for IMMW Wi-Fi networks. The beam training sequence 400 (which may be equivalently referred to or understood as a sounding sequence) may implement or be implemented to realize or facilitate one or more aspects of the wireless communication network 100 or the signaling diagram 200. For example, the beam training sequence 400 may be an example of the beam training sequence 222 (with assistance from a sub-7 GHz link) between the first communication device 202 and the second communication device 204, as illustrated by and described with reference to FIG. 2. The first communication device 202 and the second communication device 204 may each support at least one sub-7 GHz link and a 60 GHz link, such as the sub-7 GHz link 206 and the 60 GHz link 208 as illustrated and described with reference to FIG. 2.

In some implementations, the first communication device 202 may transmit, via the sub-7 GHz link, an action frame 402. The action frame 402 may be a beamforming setup frame or an NDPA frame, among other example action frames or other frame types. For example, the action frame 402 may be any frame that indicates information that pertains to the beam training sequence 400 via the 60 GHz link. The first communication device 202 may transmit the action frame 402 to setup (such as indicate or configure) one or more beam training parameters. Additionally, or alternatively, the first communication device 202 may transmit the action frame 402 to provide a timing and frequency reference for the 60 GHz link. For example, the action frame 402 may include an indication of a time delta 404 between the action frame 402 and an initial NDP PPDU (which may be an example of an initial beam training packet) sent via the 60 GHz link. In some implementations, the time delta 404 may be a default or fixed value, such as a value defined by a network specification or a value indicated from a set of possible values defined by a network specification. The second communication device 204 may transmit an ACK 406 in response to the action frame 402. In some implementations, the action frame 402 and the ACK 406 may be replaced by another message exchange sequence, such as a request message, a response message (responsive to the request message), and an NDPA or other action frame (subsequent to the response message).

In some aspects, the beam training sequence 400 illustrates a 1D beam scanning operation according to which the first communication device 202 indicates the beam training parameters for each phase of at least an SLS stage of the beam training sequence 400. In other words, the beam training sequence 400 illustrates a modular approach according to which the first communication device 202 (such as an AP 102) transmits an action frame prior to each phase of at least the SLS stage. For example, the first communication device 202 may transmit first NDP PPDUs 408 (which may be an example of the first NDP PPDUs 308 as illustrated by and described with reference to FIG. 3) in accordance with the one or more beam training parameters indicated by the action frame 402 and may transmit an action frame 414 that indicates one or more beam training parameters for a responder Tx-SLS phase of the beam training sequence 400. In other words, each phase of at least the SLS stage of the beam training sequence 400 may include a sequence of an action frame transmitted via the sub-7 GHz link+NDP PPDUs transmitted via the 60 GHz link+(triggered) SLS/CSI feedback, with the action frame of each phase carrying (such as indicating) the beam training parameters for the current training phase (such as for only the current training phase). In some aspects, the first communication device 202 may measure the sub-7 GHz link to determine whether the sub-7 GHz link is available after the action frame 402 and prior to the action frame 414.

In some implementations, prior to the action frame 414, the first communication device 202 may transmit a trigger frame 410 that solicits feedback 412 (shown as “FB” in the illustration of FIG. 4) from the second communication device 204, the feedback 412 including or indicating SLS/CSI feedback measured by the second communication device 204 using the first NDP PPDUs 408. For example, the second communication device 204 may transmit the feedback 412 a short interframe space (SIFS) duration after receiving the trigger frame 410. In some aspects, the first communication device 202 may selectively transmit the trigger frame 410, such as in accordance with whether the beam training sequence 400 is a trigger-based sounding sequence. Further, as an alternative to transmitting the feedback 412 via the sub-7 GHz link via a separate frame or PPDU, the second communication device 204 may indicate the feedback 412 via at least one of a set of second NDP PPDUs 420 that the second communication device 204 transmits via the 60 GHz link. The first NDP PPDUs 408 may be an example of a set of first beam training packets and the second NDP PPDUs 420 may be an example of a set of second beam training packets.

The second communication device 204 may transmit the second NDP PPDUs 420 via the 60 GHz link in accordance with the one or more beam training parameters indicated by the action frame 414. The second communication device 204 may transmit an ACK 418 in response to the action frame 414. The action frame 414 may indicate a time delta 416 between the action frame 414 and an initial NDP PPDU of the second NDP PPDUs 420. In some implementations, the time delta 416 may be a default or fixed value, such as a value defined by a network specification or a value indicated from a set of possible values defined by a network specification. In accordance with the beam training parameters indicated by the action frame 414, the second communication device 204 may transmit each NDP PPDU of the second NDP PPDUs 420 using a respective transmit beam of the second communication device 204. The first communication device 202 may monitor for the second NDP PPDUs 420 using a single receive beam (such as a quasi-omnidirectional receive beam) in accordance with the beam training parameters indicated by the action frame 414.

In some implementations, the first communication device 202 may transmit feedback 422-a via the sub-7 GHz link or feedback 422-b via the 60 GHz link. The feedback 422-a or the feedback 422-b may be on at least one transmit beam used by the second communication device 204 to transmit the second NDP PPDUs 420. For example, the feedback 422-a or the feedback 422-b may include or indicate SLS/CSI feedback measured by the first communication device 202 using the second NDP PPDUs 420. In some implementations, the first communication device 202 may transmit the feedback 422-b via a first PPDU of an initiator BRP-Rx phase of the beam training sequence 400, which may follow the second NDP PPDUs 420. In examples in which the first communication device 202 transmits a first PPDU as part of an initiator BRP-Rx phase, the second communication device 204 may transmit a second PPDU as part of a responder BRP-Rx phase. Each of such first and second PPDUs may include multiple TRN subfields with a structure that is in accordance with a respective beam training direction.

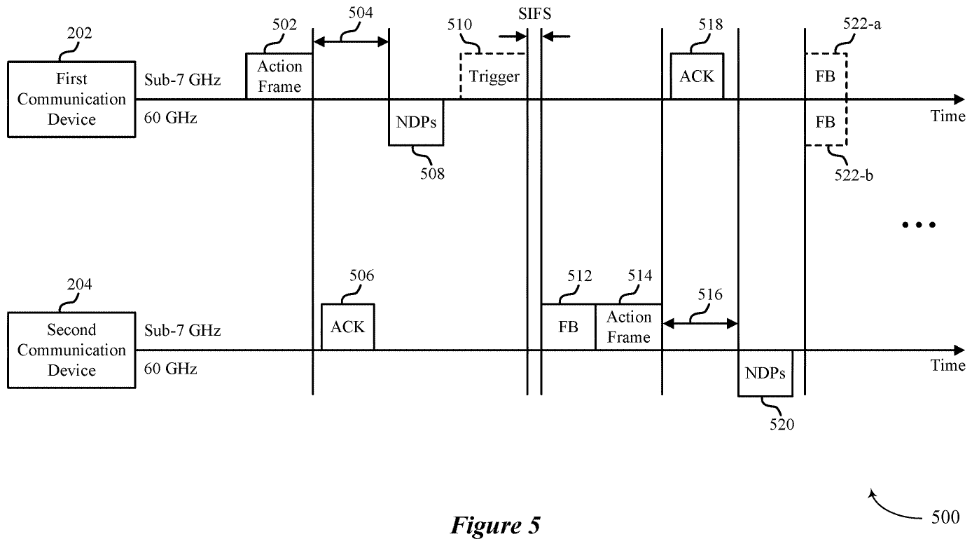

FIG. 5 shows an example beam training sequence 500 that supports 60 GHz beam training designs for IMMW Wi-Fi networks. The beam training sequence 500 (which may be equivalently referred to or understood as a sounding sequence) may implement or be implemented to realize or facilitate one or more aspects of the wireless communication network 100 or the signaling diagram 200. For example, the beam training sequence 500 may be an example of the beam training sequence 222 (with assistance from a sub-7 GHz link) between the first communication device 202 and the second communication device 204, as illustrated by and described with reference to FIG. 2. The first communication device 202 and the second communication device 204 may each support at least one sub-7 GHz link and a 60 GHz link, such as the sub-7 GHz link 206 and the 60 GHz link 208 as illustrated and described with reference to FIG. 2.

In some implementations, the first communication device 202 may transmit, via the sub-7 GHz link, an action frame 502. The action frame 502 may be a beamforming setup frame or an NDPA frame, among other example action frames or other frame types. For example, the action frame 502 may be any frame that indicates information that pertains to the beam training sequence 500 via the 60 GHz link. The first communication device 202 may transmit the action frame 502 to setup (such as indicate or configure) one or more beam training parameters. Additionally, or alternatively, the first communication device 202 may transmit the action frame 502 to provide a timing and frequency reference for the 60 GHz link. For example, the action frame 502 may include an indication of a time delta 504 between the action frame 502 and an initial NDP PPDU (which may be an example of an initial beam training packet) sent via the 60 GHz link. In some implementations, the time delta 504 may be a default or fixed value, such as a value defined by a network specification or a value indicated from a set of possible values defined by a network specification. The second communication device 204 may transmit an ACK 506 in response to the action frame 502. In some implementations, the action frame 502 and the ACK 506 may be replaced by another message exchange sequence, such as a request message, a response message (responsive to the request message), and an NDPA or other action frame (subsequent to the response message).

In some aspects, the beam training sequence 500 illustrates a 1D beam scanning operation according to which an NDP PPDU transmitter indicates the beam training parameters for each phase of at least an SLS stage of the beam training sequence 500. In other words, the beam training sequence 500 illustrates a modular approach according to which the first communication device 202 (such as an AP 102) transmits an action frame prior to (and to define) an initiator Tx-SLS phase and according to which the second communication device 204 (such as a STA 104) transmits another action frame prior to a responder Tx-SLS phase. For example, the first communication device 202 may transmit first NDP PPDUs 508 (which may be an example of the first NDP PPDUs 214 of FIG. 2, the first NDP PPDUs 308 of FIG. 3, or the first NDP PPDUs 408 of FIG. 4) in accordance with the one or more beam training parameters indicated by the action frame 502 and the second communication device 204 may transmit an action frame 514 that indicates one or more beam training parameters for the responder Tx-SLS phase of the beam training sequence 500. In other words, each phase of at least the SLS stage of the beam training sequence 500 may include a sequence of an action frame transmitted via the sub-7 GHz link+NDP PPDUs transmitted via the 60 GHz link+(triggered) SLS/CSI feedback, with the action frame of each phase carrying (such as indicating) the beam training parameters for the current training phase (such as for only the current training phase) and being transmitted by the NDP PPDU transmitter of that phase. In some aspects, the second communication device 204 may measure (such as sense) the sub-7 GHz link to determine whether the sub-7 GHz link is available after the action frame 502 and prior to the action frame 514.

In some implementations, prior to the action frame 514, the first communication device 202 may transmit a trigger frame 510 that solicits feedback 512 (shown as “FB” in the illustration of FIG. 5) from the second communication device 204, the feedback 512 including or indicating SLS/CSI feedback measured by the second communication device 204 using the first NDP PPDUs 508. For example, the second communication device 204 may transmit the feedback 512 a SIFS duration after receiving the trigger frame 510. In some aspects, the first communication device 202 may selectively transmit the trigger frame 510, such as in accordance with whether the beam training sequence 500 is a trigger-based sounding sequence. Further, as an alternative to transmitting the feedback 512 via the sub-7 GHz link via a separate frame or PPDU, the second communication device 204 may indicate the feedback 512 via the action frame 514 or via at least one of a set of second NDP PPDUs 520 that the second communication device 204 transmits via the 60 GHz link.

The second communication device 204 may transmit second NDP PPDUs 520 via the 60 GHz link in accordance with the one or more beam training parameters indicated by the action frame 514. The first communication device 202 may transmit an ACK 518 in response to the action frame 514, which the second communication device 204 may receive prior to transmitting the second NDP PPDUs 520. The action frame 514 may indicate a time delta 516 between the action frame 514 and an initial NDP PPDU of the second NDP PPDUs 520. In some implementations, the time delta 516 may be a default or fixed value, such as a value defined by a network specification or a value indicated from a set of possible values defined by a network specification. In accordance with the beam training parameters indicated by the action frame 514, the second communication device 204 may transmit each NDP PPDU of the second NDP PPDUs 520 using a respective transmit beam of the second communication device 204. The first communication device 202 may monitor for the second NDP PPDUs 520 using a single receive beam (such as a quasi-omnidirectional receive beam) in accordance with the beam training parameters indicated by the action frame 514. The first NDP PPDUs 508 may be an example of a set of first beam training packets and the second NDP PPDUs 520 may be an example of a set of second beam training packets.

In some implementations, the first communication device 202 may transmit feedback 522-a via the sub-7 GHz link or feedback 522-b via the 60 GHz link. The feedback 522-a or the feedback 522-b may be on at least one transmit beam used by the second communication device 204 to transmit the second NDP PPDUs 520. For example, the feedback 522-a or the feedback 522-b may include or indicate SLS/CSI feedback measured by the first communication device 202 using the second NDP PPDUs 520. In some implementations, the first communication device 202 may transmit the feedback 522-b via a first PPDU of an initiator BRP-Rx phase of the beam training sequence 500, which may follow the second NDP PPDUs 520. In examples in which the first communication device 202 transmits a first PPDU as part of an initiator BRP-Rx phase, the second communication device 204 may transmit a second PPDU as part of a responder BRP-Rx phase. Each of such first and second PPDUs may include multiple TRN subfields with a structure that is in accordance with a respective beam training direction.

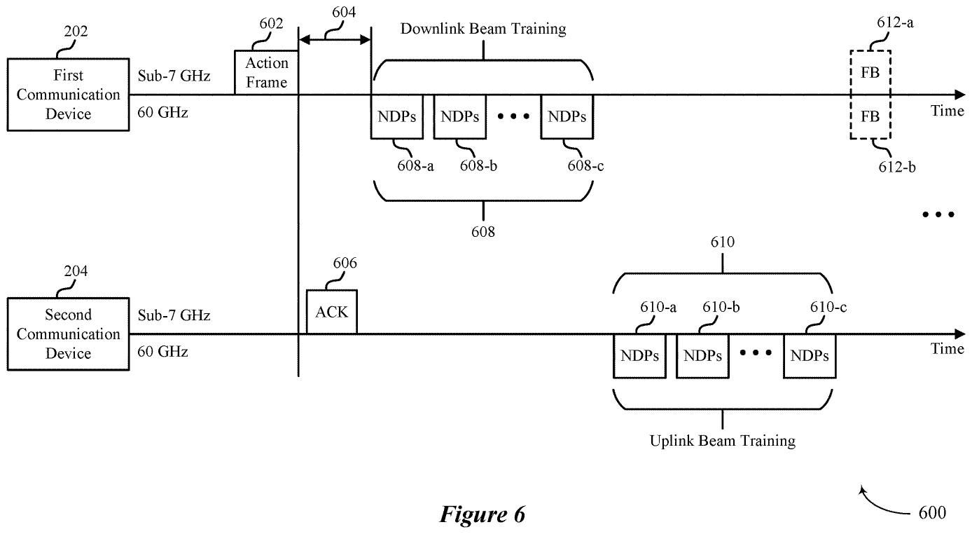

FIG. 6 shows an example beam training sequence 600 that supports 60 GHz beam training designs for IMMW Wi-Fi networks. The beam training sequence 600 (which may be equivalently referred to or understood as a sounding sequence) may implement or be implemented to realize or facilitate one or more aspects of the wireless communication network 100 or the signaling diagram 200. For example, the beam training sequence 600 may be an example of the beam training sequence 222 (with assistance from a sub-7 GHz link) between the first communication device 202 and the second communication device 204, as illustrated by and described with reference to FIG. 2. The first communication device 202 and the second communication device 204 may each support at least one sub- 7 GHz link and a 60 GHz link, such as the sub-7 GHz link 206 and the 60 GHz link 208 as illustrated and described with reference to FIG. 2.

In some implementations, the first communication device 202 may transmit, via the sub-7 GHz link, an action frame 602. The action frame 602 may be a beamforming setup frame or an NDPA frame, among other example action frames or other frame types. For example, the action frame 602 may be any frame that indicates information that pertains to the beam training sequence 600 via the 60 GHz link. The first communication device 202 may transmit the action frame 602 to set up (such as indicate or configure) one or more beam training parameters. Additionally, or alternatively, the first communication device 202 may transmit the action frame 602 to provide a timing and frequency reference for the 60 GHz link. For example, the action frame 602 may include an indication of a time delta 604 between the action frame 602 and an initial NDP PPDU (which may be an example of an initial beam training packet) sent via the 60 GHz link. In some implementations, the time delta 604 may be a default or fixed value, such as a value defined by a network specification or a value indicated from a set of possible values defined by a network specification. The second communication device 204 may transmit an ACK 606 in response to the action frame 602. In some implementations, the action frame 602 and the ACK 606 may be replaced by another message exchange sequence, such as a request message, a response message (responsive to the request message), and an NDPA or other action frame (subsequent to the response message).

In some aspects, the beam training sequence 600 illustrates a 2D beam scanning operation according to which the first communication device 202 and the second communication device 204 perform downlink beam training and uplink beam training. In some aspects, the action frame 602 transmitted by the first communication device 202 via the sub-7 GHz link carries (such as indicates or provides) a complete set of beam training parameters for the beam training sequence 600 (such as all the beam training parameters throughout the full training procedure). In such aspects, the first communication device 202 may transmit multiple first NDP PPDU sets 608 via the 60 GHz link in accordance with the beam training parameters indicated by the action frame 602 and the second communication device 204 may transmit multiple second NDP PPDU sets 610 via the 60 GHz link in accordance with the beam training parameters indicated by the action frame 602. In accordance with the beam training parameters indicated by the action frame 602, the first communication device 202 may transmit each NDP PPDU of a given first NDP PPDU set 608 via a respective first transmit beam of the first communication device 202 and the second communication device 204 may transmit each NDP PPDU of a given second NDP PPDU set 610 via a respective second transmit beam of the second communication device 204. The first NDP PPDU set 608 may be an example of a set of first beam training packets and the second NDP PPDU set 610 may be an example of a set of second beam training packets.

For example, the first communication device 202 may transmit a first set of NDP PPDUs 608-a, a second set of NDP PPDUs 608-b, and an N^{th} set of NDP PPDUs 608-c in accordance with the beam training parameters indicated by the action frame 602. The first communication device 202 may transmit each NDP PPDU of the first set of NDP PPDUs 608-a using a respective transmit beam of a set of transmit beams, with the second set of NDP PPDUs 608-b and the N^{th} set of NDP PPDUs 608-c being repeated versions of the first set of NDP PPDUs 608-a. In other words, the first set of NDP PPDUs 608-a may include Tx-SLS beamforming and the second set of NDP PPDUs 608-b and the N^{th} set of NDP PPDUs 608-c may include repeated Tx-SLS beamforming. The second communication device 204 may receive each NDP PPDU set using a respective receive beam of the second communication device 204. For example, the second communication device 204 may monitor for the first set of NDP PPDUs 608-a using a first receive beam, may monitor for the second set of NDP PPDUs 608-b using a second receive beam, and may monitor for the N^{th} set of NDP PPDUs 608-c using an N^{th} (such as a last) receive beam.

By way of further example, the second communication device 204 may transmit a first set of NDP PPDUs 610-a, a second set of NDP PPDUs 610-b, and an N^{th} set of NDP PPDUs 610-c in accordance with the beam training parameters indicated by the action frame 602. The second communication device 204 may transmit each NDP PPDU of the first set of NDP PPDUs 610-a using a respective transmit beam of a set of transmit beams, with the second set of NDP PPDUs 610-b and the N^{th} set of NDP PPDUs 610-c being repeated versions of the first set of NDP PPDUs 610-a. In other words, the first set of NDP PPDUs 610-a may include Tx-SLS beamforming and the second set of NDP PPDUs 610-b and the N^{th} set of NDP PPDUs 610-c may include repeated Tx-SLS beamforming. The first communication device 202 may receive each NDP PPDU set using a respective receive beam of the first communication device 202. For example, the first communication device 202 may monitor for the first set of NDP PPDUs 610-a using a first receive beam, may monitor for the second set of NDP PPDUs 610-b using a second receive beam, and may monitor for the N^{th} set of NDP PPDUs 610-c using an N^{th} (such as a last) receive beam. In some aspects, at least one NDP PPDU transmitted by the second communication device 204 may include feedback on a transmit beam used by the first communication device 202, such as SLS/CSI feedback measured by the second communication device 204 using the multiple first NDP PPDU sets 608.

In some implementations, the first communication device 202 may transmit feedback 612-a via the sub-7 GHz link or feedback 612-b via the 60 GHz link. The feedback 612-a or the feedback 612-b may be on at least one transmit beam used by the second communication device 204 to transmit the multiple second NDP PPDU sets 610. For example, the feedback 612-a or the feedback 612-b may include or indicate SLS/CSI feedback measured by the first communication device 202 using the multiple second NDP PPDU sets 610. For example, within the beam training sequence 600, SLS/CSI feedback information may be carried or indicated by the NDP PPDUs in the following phase. In some aspects, SLS/CSI feedback may be communicated after each round of Tx-SLS (such as after an initial Tx-SLS or after a repeated Tx-SLS, such as after the first set of NDP PPDUs 608-a or after the second set of NDP PPDUs 608-b, among other examples), which may enable an early termination of training with a potential tradeoff of higher overhead.

In some implementations, the first communication device 202 may transmit the feedback 612-b via a first PPDU of an initiator BRP-Rx phase of the beam training sequence 600, which may follow the multiple second NDP PPDU sets 610. In examples in which the first communication device 202 transmits a first PPDU as part of an initiator BRP-Rx phase, the second communication device 204 may transmit a second PPDU as part of a responder BRP-Rx phase. Each of such first and second PPDUs may include multiple TRN subfields with a structure that is in accordance with a respective beam training direction.

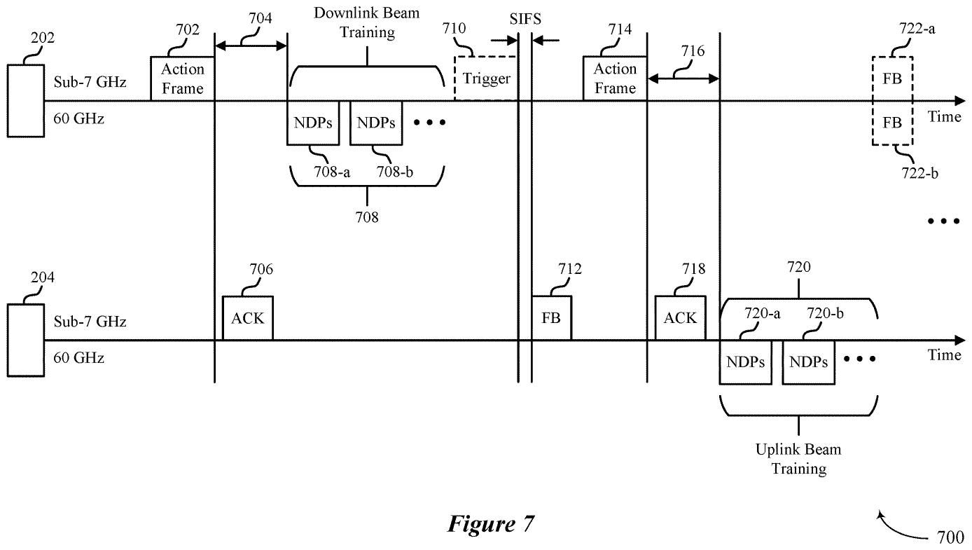

FIG. 7 shows an example beam training sequence 700 that supports 60 GHz beam training designs for IMMW Wi-Fi networks. The beam training sequence 700 (which may be equivalently referred to or understood as a sounding sequence) may implement or be implemented to realize or facilitate one or more aspects of the wireless communication network 100 or the signaling diagram 200. For example, the beam training sequence 700 may be an example of the beam training sequence 222 (with assistance from a sub-7 GHz link) between the first communication device 202 and the second communication device 204, as illustrated by and described with reference to FIG. 2. The first communication device 202 and the second communication device 204 may each support at least one sub-7 GHz link and a 60 GHz link, such as the sub-7 GHz link 206 and the 60 GHz link 208 as illustrated and described with reference to FIG. 2.

In some implementations, the first communication device 202 may transmit, via the sub-7 GHz link, an action frame 702. The action frame 702 may be a beamforming setup frame or an NDPA frame, among other example action frames or other frame types. For example, the action frame 702 may be any frame that indicates information that pertains to the beam training sequence 700 via the 60 GHz link. The first communication device 202 may transmit the action frame 702 to set up (such as indicate or configure) one or more beam training parameters. Additionally, or alternatively, the first communication device 202 may transmit the action frame 702 to provide a timing and frequency reference for the 60 GHz link. For example, the action frame 702 may include an indication of a time delta 704 between the action frame 702 and an initial NDP PPDU (which may be an example of an initial beam training packet) sent via the 60 GHz link. In some implementations, the time delta 704 may be a default or fixed value, such as a value defined by a network specification or a value indicated from a set of possible values defined by a network specification. The second communication device 204 may transmit an ACK 706 in response to the action frame 702. In some implementations, the action frame 702 and the ACK 706 may be replaced by another message exchange sequence, such as a request message, a response message (responsive to the request message), and an NDPA or other action frame (subsequent to the response message).

In some aspects, the beam training sequence 700 illustrates a 2D beam scanning operation according to which the first communication device 202 and the second communication device 204 perform downlink beam training and uplink beam training. In some aspects, the first communication device 202 indicates the beam training parameters for each phase of the first beam training stage (e.g., downlink beam training stage) of the beam training sequence 700. In other words, the beam training sequence 700 illustrates a modular approach according to which the first communication device 202 (such as an AP 102) transmits an action frame prior to each phase of at least the SLS stage. For example, the first communication device 202 may transmit multiple first NDP PPDU sets 708 (which may be an example of the multiple first NDP PPDU sets 608 of FIG. 6) in accordance with the one or more beam training parameters indicated by the action frame 702 and may transmit an action frame 714 that indicates one or more beam training parameters for each phase of the second stage (e.g., uplink beam training stage) of the beam training sequence 700. In other words, each phase of the respective beam training stage of the beam training sequence 700 may include a sequence of an action frame transmitted via the sub-7 GHz link+NDP PPDUs transmitted via the 60 GHz link+(triggered) SLS/CSI feedback, with the action frame of each phase carrying (such as indicating) the beam training parameters for the current training phase (such as for only the current training phase). In some aspects, the first communication device 202 may measure the sub-7 GHz link to determine whether the sub-7 GHz link is available after the action frame 702 and prior to the action frame 714.

In some implementations, prior to the action frame 714, the first communication device 202 may transmit a trigger frame 710 that solicits feedback 712 (shown as “FB” in the illustration of FIG. 7) from the second communication device 204, the feedback 712 including or indicating SLS/CSI feedback measured by the second communication device 204 using the multiple first NDP PPDU sets 708. For example, the second communication device 204 may transmit the feedback 712 a SIFS duration after receiving the trigger frame 710. In some aspects, the first communication device 202 may selectively transmit the trigger frame 710, such as in accordance with whether the beam training sequence 700 is a trigger-based sounding sequence. Further, as an alternative to transmitting the feedback 712 via a separate frame or PPDU via the sub-7 GHz link, the second communication device 204 may indicate the feedback 712 via at least one NDP PPDU of multiple second NDP PPDU sets 720 (which may be an example of the multiple second NDP PPDU sets 610 of FIG. 6) that the second communication device 204 transmits via the 60 GHz link. The first NDP PPDU sets 708 may be an example of first beam training packet sets and the second NDP PPDU sets 610 may be an example of second beam training packet sets.

The second communication device 204 may transmit the multiple second NDP PPDU sets 720 via the 60 GHz link in accordance with the one or more beam training parameters indicated by the action frame 714. The second communication device 204 may transmit an ACK 718 in response to the action frame 714. The action frame 714 may indicate a time delta 716 between the action frame 714 and an initial NDP PPDU of the multiple second NDP PPDU sets 720. In some implementations, the time delta 716 may be a default or fixed value, such as a value defined by a network specification or a value indicated from a set of possible values defined by a network specification. In accordance with the beam training parameters indicated by the action frame 714, the second communication device 204 may transmit each NDP PPDU of a given second NDP PPDU set 720 using a respective transmit beam of the second communication device 204. The first communication device 202 may monitor for the multiple second NDP PPDU sets 720 using multiple receive beams in accordance with the beam training parameters indicated by the action frame 714.

For example, in accordance with the 2D scanning, the first communication device 202 may transmit a first set of NDP PPDUs 708-a, a second set of NDP PPDUs 708-b, and so on up to an N^{th} set of NDP PPDUs in accordance with the beam training parameters indicated by the action frame 702. The first communication device 202 may transmit each NDP PPDU of the first set of NDP PPDUs 708-a using a respective transmit beam of a set of transmit beams, with the second set of NDP PPDUs 708-b being a repeated version of the first set of NDP PPDUs 708-a. In other words, the first set of NDP PPDUs 708-a may include Tx-SLS beamforming and the second set of NDP PPDUs 708-b may include repeated Tx-SLS beamforming. The second communication device 204 may receive each NDP PPDU set using a respective receive beam of the second communication device 204. For example, the second communication device 204 may monitor for the first set of NDP PPDUs 708-a using a first receive beam, may monitor for the second set of NDP PPDUs 708-b using a second receive beam, and may monitor for an N^{th} set of NDP PPDUs using an N^{th} (such as a last) receive beam.

By way of further example, the second communication device 204 may transmit a first set of NDP PPDUs 720-a, a second set of NDP PPDUs 720-b, and so on up to an N^{th} set of NDP PPDUs in accordance with the beam training parameters indicated by the action frame 714. The second communication device 204 may transmit each NDP PPDU of the first set of NDP PPDUs 720-a using a respective transmit beam of a set of transmit beams, with the second set of NDP PPDUs 720-b being a repeated version of the first set of NDP PPDUs 720-a. In other words, the first set of NDP PPDUs 720-a may include Tx-SLS beamforming and the second set of NDP PPDUs 720-b may include repeated Tx-SLS beamforming. The first communication device 202 may receive each NDP PPDU set using a respective receive beam of the first communication device 202. For example, the first communication device 202 may monitor for the first set of NDP PPDUs 720-a using a first receive beam, may monitor for the second set of NDP PPDUs 720-b using a second receive beam, and may monitor for an N^{th} set of NDP PPDUs using an N^{th} (such as a last) receive beam. In some aspects, at least one NDP PPDU transmitted by the second communication device 204 may include feedback on a transmit beam used by the first communication device 202, such as SLS/CSI feedback measured by the second communication device 204 using the multiple first NDP PPDU sets 708.

In some implementations, the first communication device 202 may transmit feedback 722-a via the sub-7 GHz link or feedback 722-b via the 60 GHz link. The feedback 722-a or the feedback 722-b may be on at least one transmit beam used by the second communication device 204 to transmit the multiple second NDP PPDU sets 720. For example, the feedback 722-a or the feedback 722-b may include or indicate SLS/CSI feedback measured by the first communication device 202 using the multiple second NDP PPDU sets 720. In some aspects, SLS/CSI feedback may be communicated after each round of Tx-SLS (such as after an initial Tx-SLS or after a repeated Tx-SLS, such as after the first set of NDP PPDUs 708-a or after the second set of NDP PPDUs 708-b, among other examples), which may enable an early termination of training with a potential tradeoff of higher overhead.

In some implementations, the first communication device 202 may transmit the feedback 722-b via a first PPDU of an initiator BRP-Rx phase of the beam training sequence 700, which may follow the multiple second NDP PPDU sets 720. In examples in which the first communication device 202 transmits a first PPDU as part of an initiator BRP-Rx phase, the second communication device 204 may transmit a second PPDU as part of a responder BRP-Rx phase. Each of such first and second PPDUs may include multiple TRN subfields with a structure that is in accordance with a respective beam training direction.

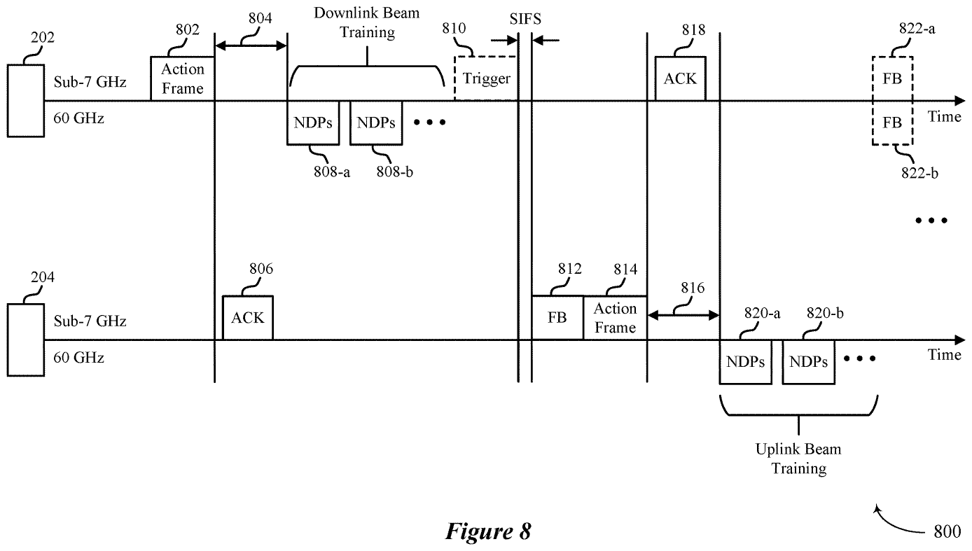

FIG. 8 shows an example beam training sequence 800 that supports 60 GHz beam training designs for IMMW Wi-Fi networks. The beam training sequence 800 (which may be equivalently referred to or understood as a sounding sequence) may implement or be implemented to realize or facilitate one or more aspects of the wireless communication network 100 or the signaling diagram 200. For example, the beam training sequence 800 may be an example of the beam training sequence 222 (with assistance from a sub-7 GHz link) between the first communication device 202 and the second communication device 204, as illustrated by and described with reference to FIG. 2. The first communication device 202 and the second communication device 204 may each support at least one sub-7 GHz link and a 60 GHz link, such as the sub-7 GHz link 206 and the 60 GHz link 208 as illustrated and described with reference to FIG. 2.

In some implementations, the first communication device 202 may transmit, via the sub-7 GHz link, an action frame 802. The action frame 802 may be a beamforming setup frame or an NDPA frame, among other example action frames or other frame types. For example, the action frame 802 may be any frame that indicates information that pertains to the beam training sequence 800 via the 60 GHz link. The first communication device 202 may transmit the action frame 802 to set up (such as indicate or configure) one or more beam training parameters. Additionally, or alternatively, the first communication device 202 may transmit the action frame 802 to provide a timing and frequency reference for the 60 GHz link. For example, the action frame 802 may include an indication of a time delta 804 between the action frame 802 and an initial NDP PPDU (which may be an example of an initial beam training packet) sent via the 60 GHz link. In some implementations, the time delta 804 may be a default or fixed value, such as a value defined by a network specification or a value indicated from a set of possible values defined by a network specification. The second communication device 204 may transmit an ACK 806 in response to the action frame 802. In some implementations, the action frame 802 and the ACK 806 may be replaced by another message exchange sequence, such as a request message, a response message (responsive to the request message), and an NDPA or other action frame (subsequent to the response message).

In some aspects, the beam training sequence 800 illustrates a 2D beam scanning operation according to which the first communication device 202 and the second communication device 204 perform downlink beam training and uplink beam training. In some aspects, the NDP PPDU transmitter indicates the beam training parameters for each phase the respective beam training stage of the beam training sequence 800. In other words, the beam training sequence 800 illustrates a modular approach according to which the first communication device 202 (such as an AP 102) transmits an action frame prior to (and to define) an initiator Tx-SLS phase and according to which the second communication device 204 (such as a STA 104) transmits another action frame prior to a responder Tx-SLS phase. For example, the first communication device 202 may transmit multiple first NDP PPDU sets 808 (which may be an example of the multiple first NDP PPDU sets 608 of FIG. 6 or the multiple first NDP PPDU sets 708 of FIG. 7) in accordance with the one or more beam training parameters indicated by the action frame 802 and the second communication device 204 may transmit an action frame 814 that indicates one or more beam training parameters for the second beam training stage of the beam training sequence 800. In other words, each phase of the respective beam training stage of the beam training sequence 800 may include a sequence of an action frame transmitted via the sub-7 GHz link+NDP PPDUs transmitted via the 60 GHz link+(triggered) SLS/CSI feedback, with the action frame of each phase carrying (such as indicating) the beam training parameters for the current training phase (such as for only the current training phase) and being transmitted by the NDP PPDU transmitter of that phase. In some aspects, the second communication device 204 may measure (such as sense) the sub-7 GHz link to determine whether the sub-7 GHz link is available after the action frame 802 and prior to the action frame 814.

In some implementations, prior to the action frame 814, the first communication device 202 may transmit a trigger frame 810 that solicits feedback 812 (shown as “FB” in the illustration of FIG. 7) from the second communication device 204, the feedback 812 including or indicating SLS/CSI feedback measured by the second communication device 204 using the multiple first NDP PPDU sets 808. For example, the second communication device 204 may transmit the feedback 812 a SIFS duration after receiving the trigger frame 810. In some aspects, the first communication device 202 may selectively transmit the trigger frame 810, such as in accordance with whether the beam training sequence 800 is a trigger-based sounding sequence. Further, as an alternative to transmitting the feedback 812 via the sub-7 GHz link via a separate frame or PPDU, the second communication device 204 may indicate the feedback 812 via at least one NDP PPDU of multiple second NDP PPDU sets 820 (which may be an example of the multiple second NDP PPDU sets 610 of FIG. 6 or the multiple second NDP PPDU sets 720 of FIG. 7) that the second communication device 204 transmits via the 60 GHz link. The first NDP PPDU sets 808 may be an example of first beam training packet sets and the second NDP PPDU sets 820 may be an example of second beam training packet sets.

The second communication device 204 may transmit the multiple second NDP PPDU sets 820 via the 60 GHz link in accordance with the one or more beam training parameters indicated by the action frame 814. The first communication device 202 may transmit an ACK 818 in response to the action frame 814. The action frame 814 may indicate a time delta 816 between the action frame 814 and an initial NDP PPDU of the multiple second NDP PPDU sets 820. In some implementations, the time delta 816 may be a default or fixed value, such as a value defined by a network specification or a value indicated from a set of possible values defined by a network specification. In accordance with the beam training parameters indicated by the action frame 814, the second communication device 204 may transmit each NDP PPDU of a given second NDP PPDU set 820 using a respective transmit beam of the second communication device 204. The first communication device 202 may monitor for the multiple second NDP PPDU sets 820 using multiple receive beams in accordance with the beam training parameters indicated by the action frame 814.

For example, in accordance with the 2D scanning, the first communication device 202 may transmit a first set of NDP PPDUs 808-a, a second set of NDP PPDUs 808-b, and so on up to an N^{th} set of NDP PPDUs in accordance with the beam training parameters indicated by the action frame 802. The first communication device 202 may transmit each NDP PPDU of the first set of NDP PPDUs 808-a using a respective transmit beam of a set of transmit beams, with the second set of NDP PPDUs 808-b being a repeated version of the first set of NDP PPDUs 808-a. In other words, the first set of NDP PPDUs 808-a may include Tx-SLS beamforming and the second set of NDP PPDUs 808-b may include repeated Tx-SLS beamforming. The second communication device 204 may receive each NDP PPDU set using a respective receive beam of the second communication device 204. For example, the second communication device 204 may monitor for the first set of NDP PPDUs 808-a using a first receive beam, may monitor for the second set of NDP PPDUs 808-b using a second receive beam, and may monitor for an N^{th} set of NDP PPDUs using an N^{th} (such as a last) receive beam.

By way of further example, the second communication device 204 may transmit a first set of NDP PPDUs 820-a, a second set of NDP PPDUs 820-b, and so on up to an N^{th} set of NDP PPDUs in accordance with the beam training parameters indicated by the action frame 814. The second communication device 204 may transmit each NDP PPDU of the first set of NDP PPDUs 820-a using a respective transmit beam of a set of transmit beams, with the second set of NDP PPDUs 820-b being a repeated version of the first set of NDP PPDUs 820-a. In other words, the first set of NDP PPDUs 820-a may include Tx-SLS beamforming and the second set of NDP PPDUs 820-b may include repeated Tx-SLS beamforming. The first communication device 202 may receive each NDP PPDU set using a respective receive beam of the first communication device 202. For example, the first communication device 202 may monitor for the first set of NDP PPDUs 820-a using a first receive beam, may monitor for the second set of NDP PPDUs 820-b using a second receive beam, and may monitor for an N^{th} set of NDP PPDUs using an N^{th} (such as a last) receive beam. In some aspects, at least one NDP PPDU transmitted by the second communication device 204 may include feedback on a transmit beam used by the first communication device 202, such as SLS/CSI feedback measured by the second communication device 204 using the multiple first NDP PPDU sets 808.

In some implementations, the first communication device 202 may transmit feedback 822-a via the sub-7 GHz link or feedback 822-b via the 60 GHz link. The feedback 822-a or the feedback 822-b may be on at least one transmit beam used by the second communication device 204 to transmit the multiple second NDP PPDU sets 820. For example, the feedback 822-a or the feedback 822-b may include or indicate SLS/CSI feedback measured by the first communication device 202 using the multiple second NDP PPDU sets 820. In some aspects, SLS/CSI feedback may be communicated after each round of Tx-SLS (such as after an initial Tx-SLS or after a repeated Tx-SLS, such as after the first set of NDP PPDUs 808-a or after the second set of NDP PPDUs 808-b, among other examples), which may enable an early termination of training with a potential tradeoff of higher overhead.

In some implementations, the first communication device 202 may transmit the feedback 822-b via a first PPDU of an initiator BRP-Rx phase of the beam training sequence 800, which may follow the multiple second NDP PPDU sets 820. In examples in which the first communication device 202 transmits a first PPDU as part of an initiator BRP-Rx phase, the second communication device 204 may transmit a second PPDU as part of a responder BRP-Rx phase. Each of such first and second PPDUs may include multiple TRN subfields with a structure that is in accordance with a respective beam training direction.

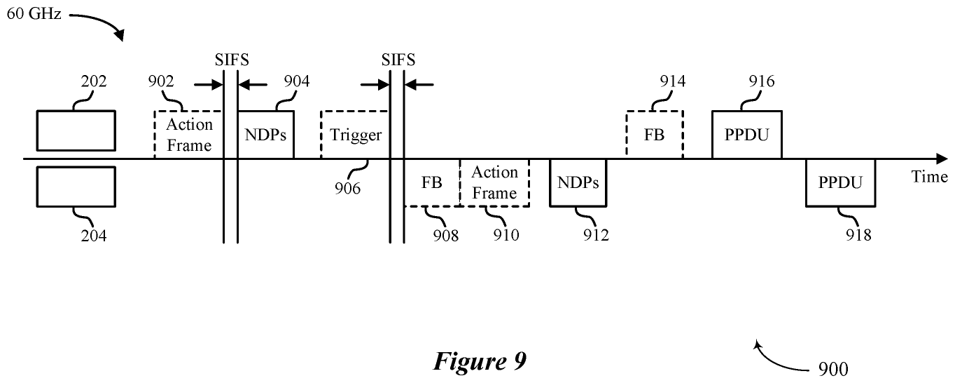

FIG. 9 shows an example beam training sequence 900 that supports 60 GHz beam training designs for IMMW Wi-Fi networks. The beam training sequence 900 (which may be equivalently referred to or understood as a sounding sequence) may implement or be implemented to realize or facilitate one or more aspects of the wireless communication network 100 or the signaling diagram 200. For example, the beam training sequence 900 may be an example of the beam training sequence 222 (without assistance from a sub-7 GHz link) between the first communication device 202 and the second communication device 204, as illustrated by and described with reference to FIG. 2. The first communication device 202 and the second communication device 204 may each support at least a 60 GHz link, such as the 60 GHz link 208 as illustrated and described with reference to FIG. 2.

In some implementations, the first communication device 202 may transmit, via the 60 GHz link, an action frame 902. The action frame 902 may be a beamforming setup frame or an NDPA frame, among other example action frames or other frame types. For example, the action frame 902 may be any frame that indicates information that pertains to the beam training sequence 900 via the 60 GHz link. The first communication device 202 may transmit the action frame 902 to set up (such as indicate or configure) one or more beam training parameters.

In some aspects, the beam training sequence 900 illustrates a 1D beam scanning operation. In accordance with the 1D beam scanning operation, the first communication device 202 may transmit a set of first NDP PPDUs 904 via the 60 GHz link. The first communication device 202 may transmit each NDP PPDU of the first NDP PPDUs 904 using a respective transmit beam of the first communication device 202. In some aspects, the first communication device 202 may transmit a first NDP PPDU of the first NDP PPDUs 904 a SIFS duration after transmitting the action frame 902. The second communication device 204 may monitor for the first NDP PPDUs 308 via the 60 GHz link using a single receive beam (such as a quasi-omnidirectional receive beam) in accordance with the beam training parameters indicated by the action frame 902. The first communication device 202 may transmit a trigger frame 906 that solicits feedback 908 (shown as “FB” in the illustration of FIG. 9) from the second communication device 204, the feedback 908 including or indicating SLS/CSI feedback measured by the second communication device 204 using the first NDP PPDUs 904. For example, the second communication device 204 may transmit the feedback 908 a SIFS duration after receiving the trigger frame 906. In some aspects, the first communication device 202 may selectively transmit the trigger frame 906, such as in accordance with whether the beam training sequence 900 is a trigger-based sounding sequence. Further, as an alternative to transmitting the feedback 908 via a separate frame or PPDU, the second communication device 204 may indicate the feedback 908 via at least one of a set of second NDP PPDUs 912 that the second communication device 204 transmits via the 60 GHz link or via an action frame 910 that the second communication device 204 may transmit via the 60 GHz link (to indicate beam training parameters for the second NDP PPDUs 912). The first NDP PPDUs 904 may be an example of a set of first beam training packets and the second NDP PPDUs 912 may be an example of a set of second beam training packets.

The second communication device 204 may transmit the second NDP PPDUs 912 via the 60 GHz link in accordance with the one or more beam training parameters indicated by the action frame 902 or the action frame 910 (if transmitted). In accordance with the beam training parameters indicated by the action frame 902 or the action frame 910, the second communication device 204 may transmit each NDP PPDU of the second NDP PPDUs 912 using a respective transmit beam of the second communication device 204. The first communication device 202 may monitor for the second NDP PPDUs 912 using a single receive beam (such as a quasi-omnidirectional receive beam) in accordance with the beam training parameters indicated by the action frame 902 or the action frame 910.

In some implementations, the first communication device 202 may transmit feedback 914 (shown as “FB” in the illustration of FIG. 9) via the 60 GHz link. The feedback 914 may be on at least one transmit beam used by the second communication device 204 to transmit the second NDP PPDUs 912. For example, the feedback 914 may include or indicate SLS/CSI feedback measured by the first communication device 202 using the second NDP PPDUs 912. In some implementations, the first communication device 202 may transmit the feedback 914 via a first PPDU 916 of an initiator BRP-Rx phase of the beam training sequence 900, which may follow the second NDP PPDUs 912. In examples in which the first communication device 202 transmits the first PPDU 916 as part of an initiator BRP-Rx phase, the second communication device 204 may transmit a second PPDU 918 as part of a responder BRP-Rx phase. Each of the first PPDU 916 and the second PPDU 918 may include multiple TRN subfields with a structure that is in accordance with a respective beam training direction.

In some implementations, the first communication device 202 may transmit one or more of the action frame 902, the trigger frame 906, or the feedback 914 using known beam directions (such as an existing/current beam direction or a most recently used beam direction, among other examples). Additionally, or alternatively, the first communication device 202 may transmit one or more of the action frame 902, the trigger frame 906, or the feedback 914 in accordance with an ELR PPDU format, which may provide additional power boosting or signal repetition to increase a reliability of such transmissions by the first communication device 202 via the 60 GHz link. In some implementations, the second communication device 204 may transmit the feedback 908 or the action frame 910, or both, using known beam directions (such as an existing/current beam direction or a most recently used beam direction, among other examples). Additionally, or alternatively, the second communication device 204 may transmit the feedback 908 or the action frame 910, or both, in accordance with an ELR PPDU format, which may provide additional power boosting or signal repetition to increase a reliability of such transmissions by the second communication device 204 via the 60 GHz link. In some implementations, the first communication device 202 and the second communication device 204 may use the beam training sequence 900 as part of a beam recovery procedure. For example, a detection of a broken link (such as a broken 60 GHz link) by the first communication device 202 or the second communication device 204 may trigger the beam training sequence 900.

In some implementations, the first communication device 202 may refrain from transmitting the action frame 902 and may instead transmit the first NDP PPDUs 904 directly. In such implementations, the first communication device 202 (and the second communication device 204) may use beam training parameters that were indicated previously (such as via previous signaling, via a sub-7 GHz link or the 60 GHz link) or that are indicated via at least one signal (SIG) field of the first NDP PPDUs 904. Further, in such implementations, the second communication device 204 may transmit the feedback 908 without the trigger frame 906 via a separate PPDU or via at least one of the second NDP PPDUs 912. The second communication device 204 may transmit the second NDP PPDUs 912 in accordance with the beam training parameters indicated by the SIG field of the first NDP PPDUs 904 or in accordance with one or more beam training parameters indicated by a SIG field of the second NDP PPDUs 912.

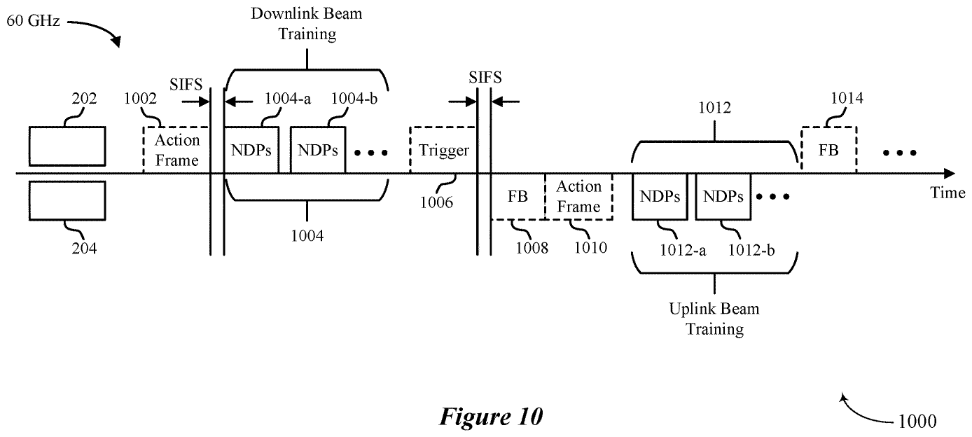

FIG. 10 shows an example beam training sequence 1000 that supports 60 GHz beam training designs for IMMW Wi-Fi networks. The beam training sequence 1000 (which may be equivalently referred to or understood as a sounding sequence) may implement or be implemented to realize or facilitate one or more aspects of the wireless communication network 100 or the signaling diagram 200. For example, the beam training sequence 1000 may be an example of the beam training sequence 222 (without assistance from a sub-7 GHz link) between the first communication device 202 and the second communication device 204, as illustrated by and described with reference to FIG. 2. The first communication device 202 and the second communication device 204 may each support at least a 60 GHz link, such as the 60 GHz link 208 as illustrated and described with reference to FIG. 2.

In some implementations, the first communication device 202 may transmit, via the 60 GHz link, an action frame 1002. The action frame 1002 may be a beamforming setup frame or an NDPA frame, among other example action frames or other frame types. For example, the action frame 1002 may be any frame that indicates information that pertains to the beam training sequence 1000 via the 60 GHz link. The first communication device 202 may transmit the action frame 1002 to set up (such as indicate or configure) one or more beam training parameters.

In some aspects, the beam training sequence 1000 illustrates a 2D beam scanning operation. In accordance with the 2D beam scanning operation, the first communication device 202 may transmit multiple first NDP PPDU sets 1004 in accordance with one or more beam training parameters. For example, the first communication device 202 may transmit a first set of NDP PPDUs 1004-a, a second set of NDP PPDUs 1004-b, and so on up to an N^{th} set of NDP PPDUs in accordance with the beam training parameters indicated by the action frame 1002. In some aspects, the first communication device 202 may transmit a first NDP PPDU of the first set of NDP PPDUs 1004-a a SIFS duration after transmitting the action frame 1002. The first communication device 202 may transmit each NDP PPDU of the first set of NDP PPDUs 1004-a using a respective transmit beam of a set of transmit beams, with the second set of NDP PPDUs 1004-b being a repeated version of the first set of NDP PPDUs 1004-a. In other words, the first set of NDP PPDUs 1004-a may include Tx-SLS beamforming and the second set of NDP PPDUs 1004-b may include repeated Tx-SLS beamforming. The second communication device 204 may receive each NDP PPDU set using a respective receive beam of the second communication device 204. For example, the second communication device 204 may monitor for the first set of NDP PPDUs 1004-a using a first receive beam, may monitor for the second set of NDP PPDUs 1004-b using a second receive beam, and may monitor for an N^{th} set of NDP PPDUs using an N^{th} (such as a last) receive beam.

By way of further example, the second communication device 204 may transmit multiple second NDP PPDU sets 1012. For example, the second communication device 204 may transmit a first set of NDP PPDUs 1012-a, a second set of NDP PPDUs 1012-b, and so on up to an N^{th} set of NDP PPDUs in accordance with the beam training parameters indicated by the action frame 1002 or an action frame 1010 (if transmitted). The second communication device 204 may transmit each NDP PPDU of the first set of NDP PPDUs 1012-a using a respective transmit beam of a set of transmit beams, with the second set of NDP PPDUs 1012-b being a repeated version of the first set of NDP PPDUs 1012-a. In other words, the first set of NDP PPDUs 1012-a may include Tx-SLS beamforming and the second set of NDP PPDUs 1012-b may include repeated Tx-SLS beamforming. The first communication device 202 may monitor for each NDP PPDU set using a respective receive beam of the first communication device 202. For example, the first communication device 202 may monitor for the first set of NDP PPDUs 1012-a using a first receive beam, may monitor for the second set of NDP PPDUs 1012-b using a second receive beam, and may monitor for an N^{th} set of NDP PPDUs using an N^{th} (such as a last) receive beam. The first NDP PPDU sets 1004 may be an example of first beam training packet sets and the second NDP PPDU sets 1012 may be an example of second beam training packet sets.

In some aspects, at least one NDP PPDU transmitted by the second communication device 204 may include feedback 1008 on a transmit beam used by the first communication device 202, such as SLS/CSI feedback measured by the second communication device 204 using the multiple first NDP PPDU sets 1004. Additionally, or alternatively, the first communication device 202 may transmit a trigger frame 1006 that solicits the feedback 1008 (shown as “FB” in the illustration of FIG. 10). For example, the second communication device 204 may transmit the feedback 1008 a SIFS duration after receiving the trigger frame 1006. In some aspects, as an alternative to transmitting the feedback 1008 via a separate frame or PPDU, the second communication device 204 may indicate the feedback 1008 via the action frame 1010 (which the second communication device 204 may transmit to indicate one or more beam training parameters for the multiple second NDP PPDU sets 1012).

In some implementations, the first communication device 202 may transmit feedback 1014 (shown as “FB” in the illustration of FIG. 10) via the 60 GHz link. The feedback 1014 may be on at least one transmit beam used by the second communication device 204 to transmit the multiple second NDP PPDU sets 1012. For example, the feedback 1014 may include or indicate SLS/CSI feedback measured by the first communication device 202 using the multiple second NDP PPDU sets 1012. In some implementations, the first communication device 202 may transmit the feedback 1014 via a first PPDU of an initiator BRP-Rx phase of the beam training sequence 1000, which may follow the multiple second NDP PPDU sets 1012. In examples in which the first communication device 202 transmits a first PPDU as part of an initiator BRP-Rx phase, the second communication device 204 may transmit a second PPDU as part of a responder BRP-Rx phase. Each of such first and second PPDUs may include multiple TRN subfields with a structure that is in accordance with a respective beam training direction.

In some implementations, the first communication device 202 may transmit one or more of the action frame 1002, the trigger frame 1006, or the feedback 1014 using known beam directions (such as an existing/current beam direction or a most recently used beam direction, among other examples). Additionally, or alternatively, the first communication device 202 may transmit one or more of the action frame 1002, the trigger frame 1006, or the feedback 1014 in accordance with an ELR PPDU format, which may provide additional power boosting or signal repetition to increase a reliability of such transmissions by the first communication device 202 via the 60 GHz link. In some implementations, the second communication device 204 may transmit the feedback 1008 or the action frame 1010, or both, using known beam directions (such as an existing/current beam direction or a most recently used beam direction, among other examples). Additionally, or alternatively, the second communication device 204 may transmit the feedback 1008 or the action frame 1010, or both, in accordance with an ELR PPDU format, which may provide additional power boosting or signal repetition to increase a reliability of such transmissions by the second communication device 204 via the 60 GHz link. In some implementations, the first communication device 202 and the second communication device 204 may use the beam training sequence 1000 as part of a beam recovery procedure. For example, a detection of a broken link (such as a broken 60 GHz link) by the first communication device 202 or the second communication device 204 may trigger the beam training sequence 1000.

In some implementations, the first communication device 202 may refrain from transmitting the action frame 1002 and may instead transmit the multiple first NDP PPDU sets 1004 directly. In such implementations, the first communication device 202 (and the second communication device 204) may use beam training parameters that were indicated previously (such as via previous signaling, via a sub-7 GHz link or the 60 GHz link) or that are indicated via at least one SIG field of at least one NDP PPDU of the multiple first NDP PPDU sets 1004. Further, in such implementations, the second communication device 204 may transmit the feedback 1008 without the trigger frame 1006 via a separate PPDU or via at least one NDP PPDU of the multiple second NDP PPDU sets 1012. The second communication device 204 may transmit the multiple second NDP PPDU sets 1012 in accordance with the beam training parameters indicated by the SIG field of the at least one NDP PPDU of the multiple first NDP PPDU sets 1004 or in accordance with one or more beam training parameters indicated by at least one SIG field of at least one NDP PPDU of the multiple second NDP PPDU sets 1012.

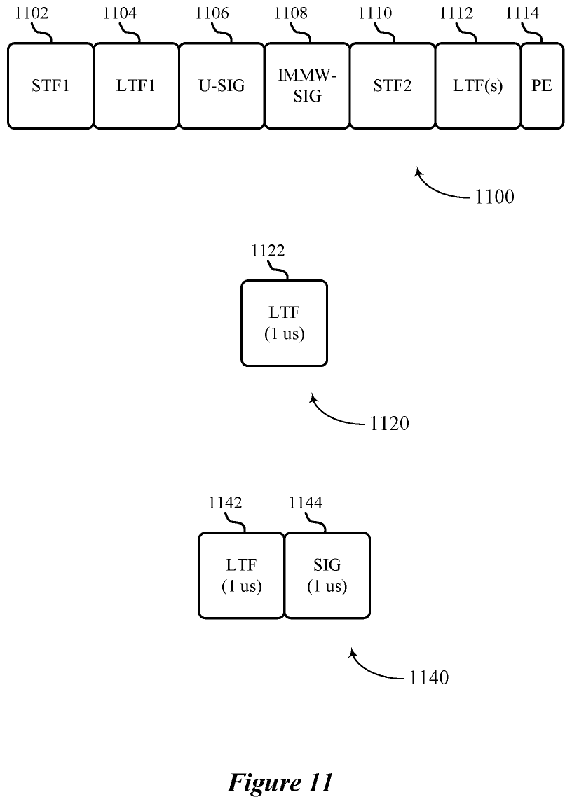

FIG. 11 shows an example NDP PPDU format 1100, an example NDP PPDU format 1120, and an example NDP PPDU format 1140 for an SLS stage of a beam training sequence that supports 60 GHz beam training designs for IMMW Wi-Fi networks. One or more of the NDP PPDU format 1100, the NDP PPDU format 1120, or the NDP PPDU format 1140 may be implemented to realize or facilitate one or more aspects disclosed herein. For example, any NDP PPDU of an SLS stage of a beam training sequence may be in accordance with the NDP PPDU format 1100, the NDP PPDU format 1120, or the NDP PPDU format 1140. Each of the NDP PPDU format 1100, the NDP PPDU format 1120, and the NDP PPDU format 1140 may be an example of a respective beam training packet format.

In accordance with the NDP PPDU format 1100, an NDP PPDU of an SLS stage may include a first STF 1102 (“STF1”), a first LTF 1104 (“LTF1”), a U-SIG field 1106, an IMMW signal (IMMW-SIG) field 1108, a second STF 1110 (“STF2”), one or more second LTFs 1112, and a packet extension (PE) field 1114. In some implementations, a PPDU type field within the U-SIG field 1106 may be set to indicate a PPDU type of SSW NDP PPDU. In some implementations, a communication device that transmits an NDP PPDU may transmit the NDP PPDU via a relatively smaller bandwidth as compared to a data PPDU bandwidth, such as via a smallest PPDU bandwidth usable by the communication device. In implementations in which a communication device uses a different bandwidth (such as a smallest allowed bandwidth) for beam training (with the different bandwidth potentially being smaller than the data PPDU bandwidth for which the beam training is intended), to reduce a frequency beam squint effect, the communication device may select (such as identify, choose, derive, or otherwise determine) a sub-channel (corresponding to the different, such as smallest allowed, bandwidth) with a center frequency close to that of the data PPDU bandwidth to reduce beam calibration error. A center frequency that is close to that of the data PPDU bandwidth may be a center frequency that is within a threshold frequency range from a center frequency of the data PPDU bandwidth.

In some implementations, the IMMW-SIG field 1108 may indicate one or more beam training parameters (and may include a total of between approximately 57 bits and approximately 89 bits). For example, the one or more beam training parameters may include a first training direction (“training direction 1”) (of 1 bit for an initiator or a responder), a second training direction (“training direction 2”) (of 1 bit for transmission or reception), an addressing mode (of 1 bit for unicast or broadcast), an MIDC indication (of 1 bit, multiple sector ID capture), a training length (of 8 bits), a count down (of 11 bits), an RF chain ID (of 2 bits), a sector ID (of 6 bits), an antenna ID (of 2 bits), a quantity of receive antennas or receive patterns (of 6 bits), a list of sector ID selected (of 6 bits or 6*3 bits), a list of antenna ID selected (of 2 bits or 2*3 bits), a signal-to-noise (SNR) report (of 8 bits or 8*3 bits), a quantity of transmit chains (of 2 bits), or any combination thereof.

In scenarios in which a beam training sequence receives assistance from signaling via a sub-7 GHz link, one or more of such beam training parameters (and potentially all of such beam training parameters) may be communicated via the sub-7 GHz link. In such scenarios, the IMMW-SIG field 1108 may be excluded from the NDP PPDU. For example, an NDP PPDU may be formatted such that the NDP PPDU includes the first STF 1102, the first LTF 1104, the U-SIG field 1106, the second STF 1110, the one or more second LTFs 1112, and the PE field 1114 and such that the NDP PPDU excludes the IMMW-SIG field 1108.

In scenarios in which signaling via the sub-7 GHz link additionally provides the timing and frequency reference for the 60 GHz link (or in scenarios in which the beam training sequence is a sub-7 GHz link triggered beam search), the NDP PPDU may be formatted in accordance with the NDP PPDU format 1120 or the NDP PPDU format 1140. For example, the NDP PPDU may be reduced to including a single training symbol (such as a single LTF 1122) in accordance with the NDP PPDU format 1120 or may be reduced to including one training symbol (such as a single LTF 1142) and one SIG symbol (such as a single SIG field 1144) for SLS feedback in accordance with the NDP PPDU format 1140.

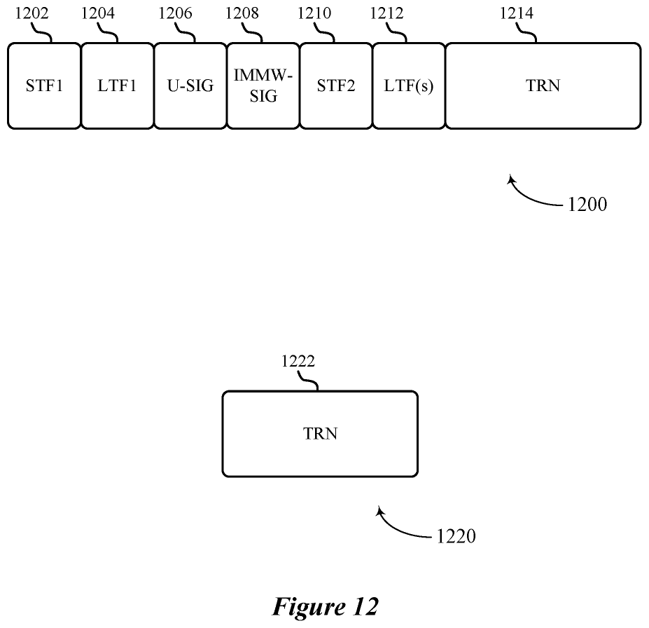

FIG. 12 shows an example PPDU format 1200 and an example PPDU format 1220 for a BRP stage of a beam training sequence that supports 60 GHz beam training designs for IMMW Wi-Fi networks. The PPDU format 1200 or the PPDU format 1220, or both, may be implemented to realize or facilitate one or more aspects disclosed herein. For example, any PPDU of a BRP stage of a beam training sequence may be in accordance with the PPDU format 1200 or the PPDU format 1220. In some implementations, a communication device may transmit a PPDU of the BRP stage via a relatively smaller bandwidth as compared to a data PPDU bandwidth or a device bandwidth, such as via a smallest PPDU bandwidth usable by the communication device. In implementations in which a communication device uses a different bandwidth (such as a smallest allowed bandwidth) for beam training (with the different bandwidth potentially being smaller than the data PPDU bandwidth for which the beam training is intended), to reduce a frequency beam squint effect, the communication device may select (such as identify, choose, derive, or otherwise determine) a sub-channel (corresponding to the different, such as smallest allowed, bandwidth) with a center frequency close to that of the data PPDU bandwidth to reduce beam calibration error. A center frequency that is close to that of the data PPDU bandwidth may be a center frequency that is within a threshold frequency range from a center frequency of the data PPDU bandwidth. In some implementations, non-TRN fields of a BRP training PPDU may have a same bandwidth and preamble format as an SSW NDP, with the TRN field having a same bandwidth as a data PPDU bandwidth or a device bandwidth.

The PPDU format 1200 and the PPDU format 1220 may be examples of BRP PPDU formats according to which the PPDU is an NDP (such as a BRP NDP). In accordance with the PPDU format 1200, a PPDU of a BRP stage may include a first STF 1202 (“STF1”), a first LTF 1204 (“LTF1”), a U-SIG field 1206, an IMMW-SIG field 1208, a second STF 1210 (“STF2”), one or more second LTFs 1212, and a TRN field 1214. The TRN field 1214 may include multiple TRN subfields with a structure that is in accordance with (such as depends on) a training direction of the PPDU of the BRP stage. In some implementations, a PPDU type field in the U-SIG field 1206 may indicate that the PPDU is a BRP NDP PPDU (which may be an example of a beam training packet, such as a BRP beam training packet).

In some implementations, a BRP beam training related field (such as the IMMW-SIG field 1208, among other example fields) may indicate one or more beam training parameters for the BRP PPDU, which may total approximately 34 bits (such as between approximately 30 bits and approximately 40 bits). Such one or more beam training parameters may include a training direction (of 2 bits for indicating Tx, Rx, or Tx/Rx), a beam tracking request (of 1 bit), a beam tracking request type (of 1 bit for analog training or baseband training, for MIMO support), a quantity of transmit chains (of 2 bits, for MIMO support), a dual polarization TRN training (of 1 bit, for MIMO support), a training length (of 8 bits), receive TRN-units per each transmit TRN-unit (of 8 bits), a TRN-unit P (of 2 bits), a TRN-unit M (of 4 bits), a TRN unit N (of 2 bits), a TRN subfield sequence length (of 2 bits), a receive pattern in BRP-Tx (of 1 bit for quasi-omnidirectional or directional antenna weight vector (AWV)), or any combination thereof.

In scenarios in which a beam training sequence receives assistance from signaling via a sub-7 GHz link, one or more of such beam training parameters (and potentially all of such beam training parameters) may be communicated via the sub-7 GHz link. In such scenarios, the IMMW-SIG field 1208 may be excluded from the BRP PPDU. For example, a BRP PPDU may be formatted such that the BRP PPDU includes the first STF 1202, the first LTF 1204, the U-SIG field 1206, the second STF 1210, the one or more second LTFs 1212, and the TRN field 1214 and such that the BRP PPDU excludes the IMMW-SIG field 1208.

In scenarios in which signaling via the sub-7 GHz link additionally provides the timing and frequency reference for the 60 GHz link (or in scenarios in which the beam training sequence is a sub-7 GHz link triggered beam search), the BRP PPDU may be formatted in accordance with the PPDU format 1220. For example, the BRP PPDU may be reduced to including a single TRN field 1222 in accordance with the PPDU format 1220. The single TRN field 1222 may include multiple TRN subfields with a structure that is in accordance with (such as depends on) a training direction of the PPDU of the BRP stage.

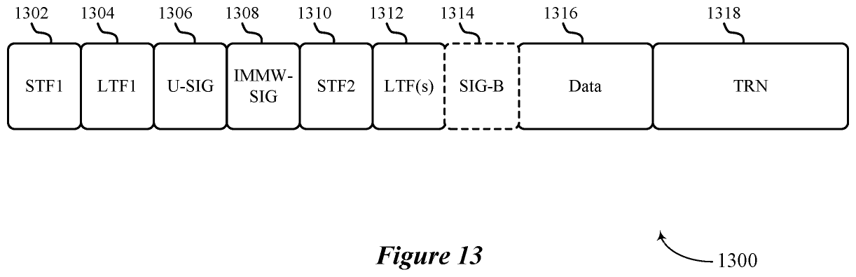

FIG. 13 shows an example PPDU format 1300 for a BRP stage of a beam training sequence that supports 60 GHz beam training designs for IMMW Wi-Fi networks. The PPDU format 1300 may be implemented to realize or facilitate one or more aspects disclosed herein. For example, any PPDU of a BRP stage of a beam training sequence may be in accordance with the PPDU format 1300. In some implementations, non-TRN fields of a BRP training PPDU may have a same bandwidth and preamble format as an SSW NDP, with the TRN field having a same bandwidth as a data PPDU bandwidth or a device bandwidth.

The PPDU format 1300 may be an example of a BRP PPDU format according to which the PPDU is data PPDU (such that a PPDU formatted according to the PPDU format 1300 may facilitate OTA BRP while transmitting data). In accordance with the PPDU format 1300, a PPDU of a BRP stage may include a first STF 1302 (“STF1”), a first LTF 1304 (“LTF1”), a U-SIG field 1306, an IMMW-SIG field 1308, a second STF 1310 (“STF2”), one or more second LTFs 1312, an optionally present signal-B (SIG-B) field 1314, a data field 1316, and a TRN field 1318. The TRN field 1318 may include multiple TRN subfields with a structure that is in accordance with (such as depends on) a training direction of the PPDU of the BRP stage. In some implementations, a PPDU type field in the U-SIG field 1306 may indicate that the PPDU is a data +BRP PPDU.

In some implementations, a demodulation related field (such as the IMMW-SIG field 1308, among other example fields) may indicate one or more data reception parameters and may total approximately 20 bits (such as between approximately 15 bits and approximately 25 bits). For example, the one or more data reception parameters may include a guard interval (GI) plus LTF (GI+LTF) size (of 2 bits), a quantity of LTF symbols (of 3 bits), a SIG-B present indication (of 1 bit), a beamformed indication (of 1 bit), an indication of a modulation and coding scheme (MCS) (of 5 bits), a quantity of spatial streams “Nss” (of 2 bits), a low-density parity check (LDPC) extra symbol segment indication (of 1 bit), a 2×LDPC indication (of 1 bit), an unequal modulation (UEQM) indication (of 3 bits, for Nss>1, otherwise reserved), an interference mitigation mode indication (of 1 bit), or any combination thereof. In some aspects, an UEQM indication may be excluded in accordance with a short distance or a small delay spread, or may indicate from different UEQM patterns in 60 GHz. In some aspects, an UEQM indication may be replaced with an individual MCS for each stream.

In some implementations, a BRP beam training related field (such as the SIG-B field 1314, among other example fields) may indicate one or more beam training parameters and may total approximately 34 bits (such as between approximately 30 bits and approximately 40 bits). For example, the one or more beam training parameters may include a training direction (of 2 bits for indicating Tx, Rx, or Tx/Rx), a beam tracking request (of 1 bit), a beam tracking request type (of 1 bit for analog training or baseband training, for MIMO support), a quantity of transmit chains (of 2 bits, for MIMO support), a dual polarization TRN training (of 1 bit, for MIMO support), a training length (of 8 bits), receive TRN-units per each transmit TRN-unit (of 8 bits), a TRN-unit P (of 2 bits), a TRN-unit M (of 4 bits), a TRN unit N (of 2 bits), a TRN subfield sequence length (of 2 bits), a receive pattern in BRP-Tx (of 1 bit for quasi-omnidirectional or directional AWV), or any combination thereof.

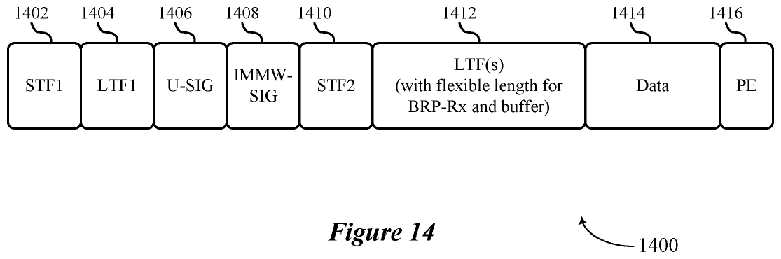

FIG. 14 shows an example PPDU format 1400 for a BRP stage of a beam training sequence that supports 60 GHz beam training designs for IMMW Wi-Fi networks. The PPDU format 1400 may be implemented to realize or facilitate one or more aspects disclosed herein. For example, any PPDU of a BRP stage of a beam training sequence may be in accordance with the PPDU format 1400. In some implementations, non-TRN fields of a BRP training PPDU may have a same bandwidth and preamble format as an SSW NDP, with the TRN field having a same bandwidth as a data PPDU bandwidth or a device bandwidth.

The PPDU format 1400 may be an example of a BRP PPDU format according to which the PPDU is data PPDU (such that a PPDU formatted according to the PPDU format 1400 may facilitate OTA BRP while transmitting data). In accordance with the PPDU format 1400, a PPDU of a BRP stage may include a first STF 1402 (“STF1”), a first LTF 1404 (“LTF1”), a U-SIG field 1406, an IMMW-SIG field 1408, a second STF 1410 (“STF2”), one or more variable or configurable length LTFs 1412, a data field 1414, and a PE field 1416. The one or more variable or configurable length LTFs 1412 may include multiple TRN subfields with a structure that is in accordance with (such as depends on) a training direction of the PPDU of the BRP stage. In some implementations, a PPDU type field in the U-SIG field 1406 may indicate that the PPDU is a data+BRP PPDU.

In some implementations, the variable (such as flexible) or configurable length LTFs 1412 may be used for BRP-Rx (to facilitate a more accurate receive antenna configuration setting) or more accurate channel estimation after BRP-Rx training (which may be used for the following data demodulation), or both. Additionally, or alternatively, a last (such as final) LTF of the LTFs 1412 may serve or function as a buffer symbol to provide more processing time to a receiving communication device. In such implementations, the BRP PPDU may exclude a SIG-B field.

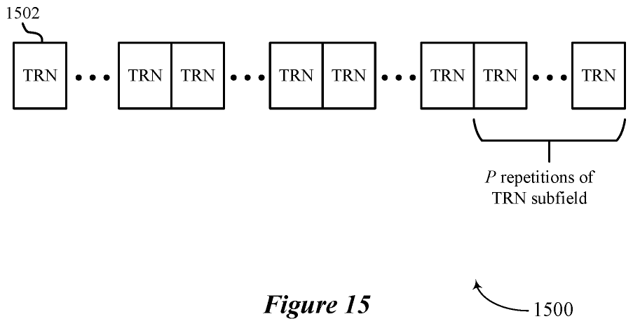

FIG. 15 shows an example TRN field structure 1500 that supports 60 GHz beam training designs for IMMW Wi-Fi networks. The TRN field structure 1500 may be implemented to realize or facilitate one or more aspects disclosed herein. For example, any TRN field associated with a beam training direction of BRP-Rx may include TRN subfields 1502 that are arranged, used, purposed, transmitted, or received in accordance with the TRN field structure 1500.

In accordance with the TRN field structure 1500, a transmitting communication device may transmit each TRN subfield 1502 of a set of TRN subfields 1502 (such as all TRN subfields 1502) with a same AWV as a data field or non-TRN fields of the PPDU that includes the TRN field. In some implementations, a receiving communication device may switch AWVs or test (such as measure) each of one or more receive elements while receiving the different TRN subfields 1502 and determine (such as measure, identify, select, derive, calculate, or otherwise ascertain) a suitable antenna configuration setting in accordance with receiving the different TRN subfields 1502 while switching AWVs or testing different receive elements. In some implementations, an additional P repetitions of the TRN subfields 1502 may be present at the end of the TRN field, which the receiving communication device may use for frequency or phase tracking.

The communication devices may coordinate on a value of P (such as via one or more signaled or indicated beam training parameters) or may use a defined or fixed value of P (such as in accordance with a network specification, a vendor-specific rule, or a specific beamforming training flow). In some implementations, a value of P may be programmable at each of the communication devices. Example values of P may include 0, 1, 2, or 4 (such that a value of P may be indicated via 2 bits).

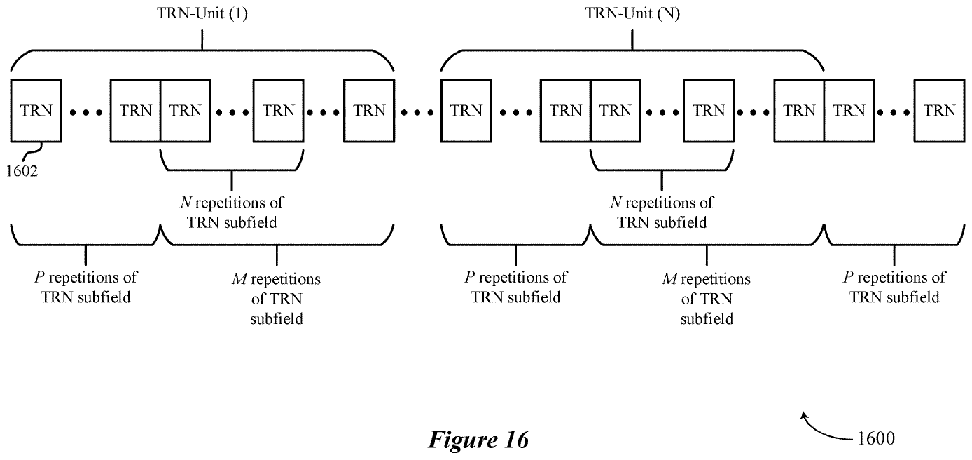

FIG. 16 shows an example TRN field structure 1600 that supports 60 GHz beam training designs for IMMW Wi-Fi networks. The TRN field structure 1600 may be implemented to realize or facilitate one or more aspects disclosed herein. For example, any TRN field associated with a beam training direction of BRP-Tx may include TRN subfields 1602 that are arranged, used, purposed, transmitted, or received in accordance with the TRN field structure 1600.

In accordance with the TRN field structure 1600, a transmitting communication device may transmit P TRN subfields 1602 with a same AWV as a data field or non-TRN fields of the PPDU that includes the TRN field, which may enable a receiving communication device to maintain synchronization and estimate the channel. In the transmission of each M TRN subfields 1602 of a TRN-unit, the transmitting communication device may change an AWV at the beginning of each N TRN subfields 1602 and maintain a same AWV over the N TRN subfields 1602.

The communication devices may coordinate on values of P, M, N, or any combination thereof (such as via one or more signaled or indicated beam training parameters) or may use a defined or fixed values of P, M, N, or any combination thereof (such as in accordance with a network specification, a vendor-specific rule, or a specific beamforming training flow). In some implementations, values of P, M, and N may be programmable at each of the communication devices. Example values of P may include 0, 1, 2, or 4 (such that a value of P may be indicated via 2 bits). M may be an integer multiple of N within an inclusive range of 1-16 (such that a value of M may be indicated via 4 bits). Example values of N may include 1, 2, either 3 or 8, or 4 (such that a value of N may be indicated via 2 bits).

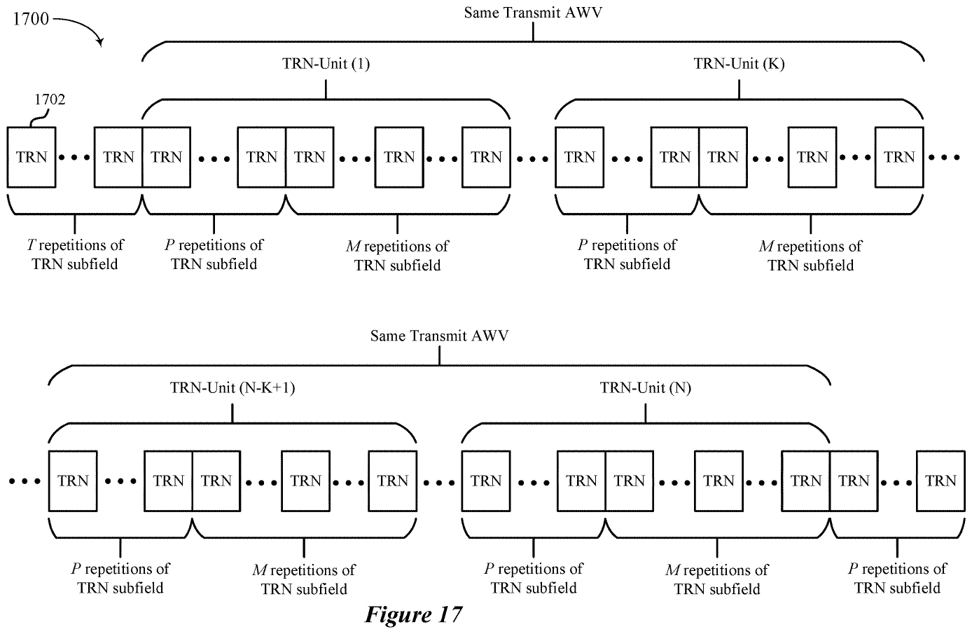

FIG. 17 shows an example TRN field structure 1700 that supports 60 GHz beam training designs for IMMW Wi-Fi networks. The TRN field structure 1700 may be implemented to realize or facilitate one or more aspects disclosed herein. For example, any TRN field associated with a beam training direction of BRP-Tx/Rx may include TRN subfields 1702 that are arranged, used, purposed, transmitted, or received in accordance with the TRN field structure 1700.

In accordance with the TRN field structure 1700, a transmitting communication device may repeatedly transmit a given TRN-unit a quantity of times to enable simultaneous training of transmit beams and receive beams. In some implementations, the transmitting communication device may use a same AWV in the transmission of M TRN subfields 1702 of a given TRN-unit, with the same TRN-unit repeated a quantity of times. In some implementations, the repeated “M TRN subfields” that are transmitted using a same transmit AWV are used for receive beam training (by or at a receiving communication device). The transmitting communication device may transmit the quantity of TRN-units with a same AWV. The number (such as quantity) of TRN-units transmitted with the same AWV is given by the receive TRN-units per each transmit TRN-unit. In some implementations, a receiving communication device may use P TRN subfields 1702 in each TRN-unit to track a frequency offset. In some implementations, T repetitions of the TRN subfields 1702 may be present at a beginning of the TRN field to provide a transitional interval for the receiving communication device.

The communication devices may coordinate on values of P, M, T, or any combination thereof (such as via one or more signaled or indicated beam training parameters) or may use a defined or fixed values of P, M, T, or any combination thereof (such as in accordance with a network specification, a vendor-specific rule, or a specific beamforming training flow). In some implementations, values of P, M, and T may be programmable at each of the communication devices.

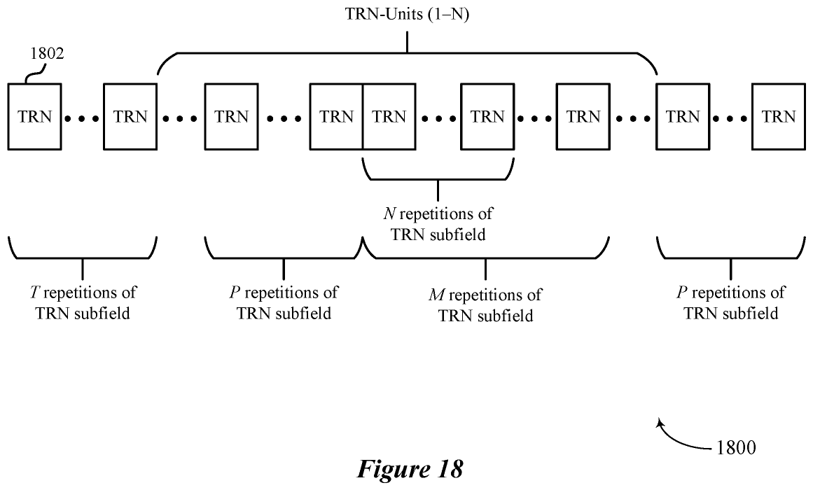

FIG. 18 shows an example TRN field structure 1800 that supports 60 GHz beam training designs for IMMW Wi-Fi networks. The TRN field structure 1800 may be implemented to realize or facilitate one or more aspects disclosed herein. For example, any TRN field may include TRN subfields 1802 that are generally arranged, used, purposed, transmitted, or received in accordance with the TRN field structure 1800. In other words, the TRN field structure 1800 illustrates an example of a general (such as generally or universally applicable) TRN structure and TRN sequence. For example, the TRN field structure 1800 may accommodate BRP-Tx, BRP-Rx, BRP-Tx/Rx, and antenna with dual polarization.

In some implementations, a transmitting communication device may generate a TRN signal per chain, with no per chain CSD applied on the TRN subfields 1802. In some implementations, each TRN subfield 1802 may include one TRN sequence in scenarios of SISO or a set of (multiple) orthogonal TRN sequences in scenarios of MIMO. In some aspects, the TRN sequence may be the same as an LTF sequence. For example, in scenarios of SISO, the TRN sequence may be equal to the LTF sequence. By way of further example, in scenarios of MIMO, the orthogonal TRN sequences for different chains or antennas may be element-wise products of the LTF sequence and respective rows of a P matrix.

The TRN subfields 1802 of the TRN field structure 1800 may include T repetitions of a TRN subfield 1802, P repetitions of a TRN subfield 1802, M repetitions of a TRN subfield 1802, and N repetitions of a TRN subfield 1802. The T repetitions of a TRN subfield 1802 may provide a transition interval. The P repetitions of a TRN subfield 1802 may facilitate channel estimation and phase tracking, having a same AWV as the preamble and data portions of the PPDU including the TRN field. The M repetitions of a TRN subfield 1802 may be for beamforming training, with same or different AWVs (depending on the beam training direction). The N repetitions of a TRN subfield 1802 may have different transmit AWVs, with Tx/Rx polarization potentially changing at the end of each N/2 TRN subfields 1802, if requested. M may be an integer multiple of N.

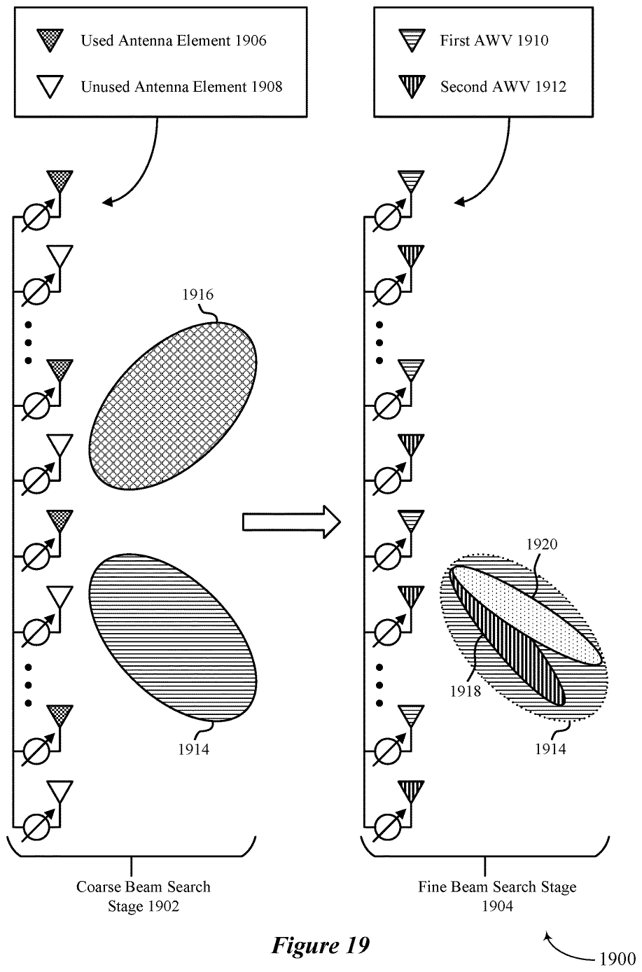

FIG. 19 shows an example two-stage beam search operation 1900 that supports 60 GHz beam training designs for IMMW Wi-Fi networks. The two-stage beam search operation 1900 may be an example of a beam training sequence as described with reference to FIG. 1-18. For example, the two-stage beam search operation 1900 may include a coarse beam search stage 1902 and a fine beam search stage 1904, with the coarse beam search stage 1902 being an example of an SLS stage of a beam training sequence and the fine beam search stage 1904 being an example of a BRP stage of the beam training sequence.

A communication device may generate transmit (or receive) beams via antenna elements of the communication device, including by applying a specific AWV to a set of antenna elements. For example, the communication device may generate different beams (such as different transmit beams or different receive beams) by applying different AWVs to a set of antenna elements. By way of further example, a first AWV may correspond to (such as result in, after an application of the first AWV to the set of antenna elements) a first beam and a second AWV may correspond to (such as result in, after an application of the second AWV to the set of antenna elements) a second beam different from the first beam.

In some implementations, a communication device may generate a coarse beam (such as a wider beam) in accordance with using a smaller quantity of antenna elements and may generate a fine beam (such as a narrower beam) in accordance with using a larger quantity of antenna elements. In such implementations, the communication device may generate a coarse beam 1914 and a coarse beam 1916 by using a subset of antenna elements 1906 of a set of antenna elements that are available for use by the communication device. In other words, the communication device may generate the coarse beam 1914 and the coarse beam 1916 by applying different AWVs to the subset of antenna elements 1906 and by not using some other antenna elements 1908. By way of example, the coarse beam 1914 may correspond to a first AWV 1910 applied to the subset of used antenna elements 1906. In some implementations, the used antenna elements 1906 may correspond to every other antenna element of the set of antenna elements that are available for use by the communication device.

The communication device may transmit PPDUs (such as NDP PPDUs or beam training packets) as part of the coarse beam search stage and, in some implementations, may receive feedback indicating the coarse beam 1914. For example, the feedback may indicate that the coarse beam 1914 is a selected transmit beam (such that the coarse beam 1914 provided a greater signal strength at a receiving communication device as compared to other coarse beams, such as the coarse beam 1916). In accordance with the feedback, the communication device may generate one or more narrower beams within the coarse beam 1914 by applying the first AWV 1910 to the originally used antenna elements 1906 (the antenna elements that were used by the communication device in the coarse beam search stage 1902) and by applying other AWVs to the originally unused antenna elements 1908 (the antenna elements that were not used by the communication device in the coarse beam search stage 1902, but that are used in the fine beam search stage 1904). For example, by applying other AWVs to the originally unused antenna elements 1908 and by keeping the AWV for the antenna elements that generate the selected coarse beam 1914 unchanged, the communication device may use all available antenna elements to generate finer beams for beam refinement search within the selected coarse beam 1914. Such finer beams may include a fine beam 1918 and a fine beam 1920. By way of example, the communication device may generate the fine beam 1918 by applying the first AWV 1910 to the originally used antenna elements 1906 and by applying the second AWV 1912 to the originally unused antenna elements 1908.

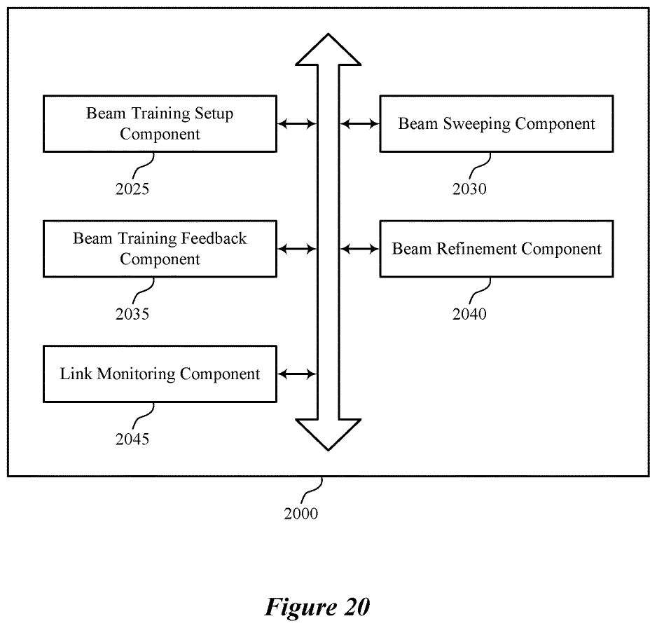

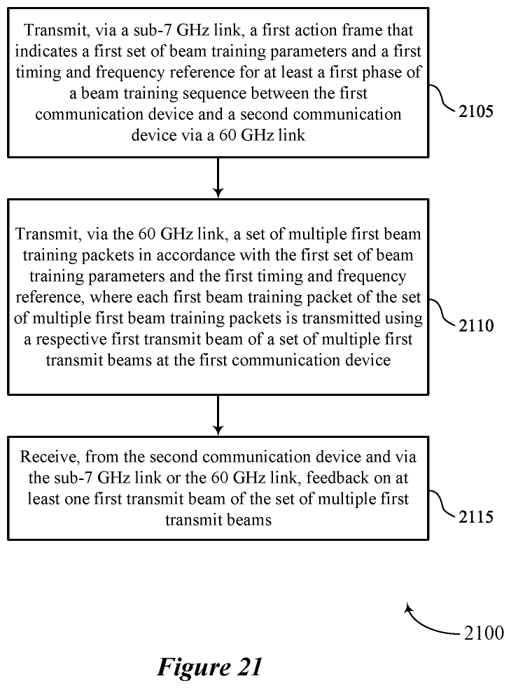

FIG. 20 shows a block diagram of an example wireless communication device 2000 that supports 60 GHz beam training designs for IMMW Wi-Fi networks. In some examples, the wireless communication device 2000 is configured to perform the processes 2100, 2200, 2300, and 2400 described with reference to FIGS. 21, 22, 23, and 24, respectively. The wireless communication device 2000 may include one or more chips, SoCs, chipsets, packages, components or devices that individually or collectively constitute or include a processing system. The processing system may interface with other components of the wireless communication device 2000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 2000 may transmit the information output from the chip. In such an example, the second interface may refer to an interface between the processing system of the chip and a reception component, such that the wireless communication device 2000 may receive information that is passed to the processing system. In some such examples, the first interface also may obtain information, such as from the transmission component, and the second interface also may output information, such as to the reception component.

The processing system of the wireless communication device 2000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2000 can be configurable or configured for use in an AP or STA, such as the AP 102 or the STA 104 described with reference to FIG. 1. In some other examples, the wireless communication device 2000 can be an AP or STA that includes such a processing system and other components including multiple antennas. The wireless communication device 2000 is capable of transmitting and receiving wireless communications in the form of, for example, wireless packets. For example, the wireless communication device 2000 can be configurable or configured to transmit and receive packets in the form of physical layer PPDUs and MPDUs conforming to one or more of the IEEE 802.11 family of wireless communication protocol standards. In some other examples, the wireless communication device 2000 can be configurable or configured to transmit and receive signals and communications conforming to one or more 3GPP specifications including those for 5G NR or 6G. In some examples, the wireless communication device 2000 also includes or can be coupled with one or more application processors which may be further coupled with one or more other memories. In some examples, the wireless communication device 2000 further includes a user interface (UI) (such as a touchscreen or keypad) and a display, which may be integrated with the UI to form a touchscreen display that is coupled with the processing system. In some examples, the wireless communication device 2000 may further include one or more sensors such as, for example, one or more inertial sensors, accelerometers, temperature sensors, pressure sensors, or altitude sensors, that are coupled with the processing system. In some examples, the wireless communication device 2000 further includes at least one external network interface coupled with the processing system that enables communication with a core network or backhaul network that enables the wireless communication device 2000 to gain access to external networks including the Internet.

The wireless communication device 2000 includes a beam training setup component 2025, a beam sweeping component 2030, a beam training feedback component 2035, a beam refinement component 2040, and a link monitoring component 2045. Portions of one or more of the beam training setup component 2025, the beam sweeping component 2030, the beam training feedback component 2035, the beam refinement component 2040, and the link monitoring component 2045 may be implemented at least in part in hardware or firmware. For example, one or more of the beam training setup component 2025, the beam sweeping component 2030, the beam training feedback component 2035, the beam refinement component 2040, and the link monitoring component 2045 may be implemented at least in part by at least a processor or a modem. In some examples, portions of one or more of the beam training setup component 2025, the beam sweeping component 2030, the beam training feedback component 2035, the beam refinement component 2040, and the link monitoring component 2045 may be implemented at least in part by a processor and software in the form of processor-executable code stored in memory.

The wireless communication device 2000 (which may be an example of a first communication device) may support wireless communication in accordance with examples as disclosed herein. The beam training setup component 2025 is configurable or configured to transmit, via a sub-7 GHz link, a first action frame that indicates a first set of beam training parameters and a first timing and frequency reference for at least a first phase of a beam training sequence between the first communication device and a second communication device via a 60 GHz link. The beam sweeping component 2030 is configurable or configured to transmit, via the 60 GHz link, a set of multiple first beam training packets (such as NDP PPDUs) in accordance with the first set of beam training parameters and the first timing and frequency reference, where each first beam training packet of the set of multiple first beam training packets is transmitted using a respective first transmit beam of a set of multiple first transmit beams at the first communication device. The beam training feedback component 2035 is configurable or configured to receive, from the second communication device and via the sub-7 GHz link or the 60 GHz link, feedback on at least one first transmit beam of the set of multiple first transmit beams.

In some examples, the link monitoring component 2045 is configurable or configured to monitor the 60 GHz link for a set of multiple second beam training packets from the second communication device, where each second beam training packet of the set of multiple second beam training packets corresponds to a respective second transmit beam of a set of multiple second transmit beams at the second communication device.

In some examples, the set of multiple second beam training packets from the second communication device is in accordance with the first set of beam training parameters indicated by the first action frame.

In some examples, at least one second beam training packet of the set of multiple second beam training packets indicates the feedback on the at least one first transmit beam of the set of multiple first transmit beams.

In some examples, the at least one second beam training packet indicates the feedback on the at least one first transmit beam via at least one SIG field of the at least one second beam training packet.

In some examples, the beam training setup component 2025 is configurable or configured to transmit, to the second communication device and via the sub-7 GHz link, a second action frame that indicates a second set of beam training parameters and a second timing and frequency reference for a second phase of the beam training sequence between the first communication device and the second communication device, where the set of multiple second beam training packets from the second communication device is in accordance with the second set of beam training parameters and the second timing and frequency reference indicated by the second action frame.

In some examples, the beam training setup component 2025 is configurable or configured to receive, from the second communication device and via the sub-7 GHz link, a second action frame that indicates second set of beam training parameters and a second timing and frequency reference for a second phase of the beam training sequence between the first communication device and the second communication device, where the set of multiple second beam training packets from the second communication device is in accordance with the second set of beam training parameters and the second timing and frequency reference indicated by the second action frame.

In some examples, the beam training feedback component 2035 is configurable or configured to transmit, via the sub-7 GHz link or the 60 GHz link, second feedback on at least one second transmit beam of the set of multiple second transmit beams in accordance with monitoring for the set of multiple second beam training packets from the second communication device.

In some examples, to support transmitting the set of multiple first beam training packets, the beam sweeping component 2030 is configurable or configured to transmit a set of multiple repeated versions of the set of multiple first beam training packets, where each repeated version of the set of multiple repeated versions corresponds to a respective receive beam, of a set of multiple receive beams at the second communication device, in accordance with the first set of beam training parameters.

In some examples, the link monitoring component 2045 is configurable or configured to monitor the 60 GHz link for a set of multiple repeated versions of a set of multiple second beam training packets from the second communication device in accordance with using a respective receive beam, of a set of multiple receive beams at the first communication device, for each repeated version of the set of multiple repeated versions, where each second beam training packet of the set of multiple second beam training packets corresponds to a respective second transmit beam of a set of multiple second transmit beams at the second communication device.

In some examples, the beam training feedback component 2035 is configurable or configured to transmit, via the sub-7 GHz link, a trigger frame that solicits the feedback from the second communication device, where the feedback is received via the sub-7 GHz link in accordance with the trigger frame that solicits the feedback being transmitted via the sub-7 GHz link.

In some examples, the beam training sequence includes an SLS stage and a BRP stage. In some examples, the SLS stage includes an exchange of a respective set of multiple beam training packets between the first communication device and the second communication device.

In some examples, the SLS stage includes the first phase of the beam training sequence and a second phase of the beam training sequence. In some examples, the first phase is an initiator transmission SLS phase, and the second phase is a responder transmission SLS phase.

In some examples, each first beam training packet of the set of multiple first beam training packets excludes an IMMW-SIG field in accordance with the first action frame, transmitted via the sub-7 GHz link, indicating the first set of beam training parameters.

In some examples, each first beam training packet of the set of multiple first beam training packets consists of a single LTF symbol or consists of a single LTF symbol and a single SIG field symbol in accordance with the first action frame, transmitted via the sub-7 GHz link, indicating the first timing and frequency reference.

In some examples, the first communication device transmits the set of multiple first beam training packets via a first bandwidth in accordance with the beam training sequence being via the 60 GHz link. In some examples, the first bandwidth is smaller than a second bandwidth used for data PPDU transmissions by the first communication device.

In some examples, the first bandwidth is a smallest PPDU bandwidth usable by the first communication device.

Additionally, or alternatively, the wireless communication device 2000 may support wireless communication in accordance with examples as disclosed herein. In some examples, the beam sweeping component 2030 is configurable or configured to transmit, via a 60 GHz link, a set of multiple first beam training packets (such as NDP PPDUs) in accordance with a beam training sequence of a beam recovery procedure between the first communication device and a second communication device on the 60 GHz link, where each first beam training packet of the set of multiple first beam training packets is transmitted using a respective first transmit beam of a set of multiple first transmit beams at the first communication device, in accordance with a first set of beam training parameters. In some examples, the beam training feedback component 2035 is configurable or configured to receive, from the second communication device and via the 60 GHz link, feedback on at least one first transmit beam of the set of multiple first transmit beams.

In some examples, the link monitoring component 2045 is configurable or configured to monitor the 60 GHz link for a set of multiple second beam training packets from the second communication device, where each second beam training packet of the set of multiple second beam training packets corresponds to a respective second transmit beam of a set of multiple second transmit beams at the second communication device.

In some examples, the set of multiple second beam training packets from the second communication device is in accordance with the first set of beam training parameters.

In some examples, at least one second beam training packet of the set of multiple second beam training packets indicates the feedback on the at least one first transmit beam of the set of multiple first transmit beams.

In some examples, the at least one second beam training packet indicates the feedback on the at least one first transmit beam via at least one SIG field of the at least one second beam training packet.

In some examples, the beam training feedback component 2035 is configurable or configured to transmit, via the 60 GHz link, second feedback on at least one second transmit beam of the set of multiple second transmit beams in accordance with monitoring for the set of multiple second beam training packets from the second communication device.

In some examples, the beam training setup component 2025 is configurable or configured to receive, from the second communication device and via the 60 GHz link, an action frame that indicates second set of beam training parameters, where reception of the set of multiple second beam training packets is in accordance with the action frame, and where the set of multiple second beam training packets from the second communication device is in accordance with the second set of beam training parameters indicated by the action frame.

In some examples, to support transmitting the set of multiple first beam training packets, the beam sweeping component 2030 is configurable or configured to transmit a set of multiple repeated versions of the set of multiple first beam training packets, where each repeated version of the set of multiple repeated versions corresponds to a respective receive beam, of a set of multiple receive beams at the second communication device, in accordance with the first set of beam training parameters.

In some examples, the link monitoring component 2045 is configurable or configured to monitor the 60 GHz link for a set of multiple repeated versions of a set of multiple second beam training packets from the second communication device in accordance with using a respective receive beam, of a set of multiple receive beams at the first communication device, for each repeated version of the set of multiple repeated versions, where each second beam training packet of the set of multiple second beam training packets corresponds to a respective second transmit beam of a set of multiple second transmit beams at the second communication device.

In some examples, the beam training feedback component 2035 is configurable or configured to transmit, via the 60 GHz link, a trigger frame that solicits the feedback from the second communication device, where the feedback is received in accordance with the trigger frame soliciting the feedback.

In some examples, the beam training setup component 2025 is configurable or configured to transmit, via the 60 GHz link, an action frame that indicates the first set of beam training parameters, where transmission of the set of multiple first beam training packets is in accordance with the action frame.

In some examples, each first beam training packet of the set of multiple first beam training packets includes an IMMW-SIG field that indicates a respective subset of the first set of beam training parameters according to which that first beam training packet is transmitted.

In some examples, the beam training sequence includes an SLS stage and a BRP stage. In some examples, the SLS stage includes an exchange of a respective set of multiple beam training packets between the first communication device and the second communication device exclusively via the 60 GHz link in accordance with the beam recovery procedure on the 60 GHz link.

In some examples, the SLS stage includes at least one PPDU that includes an action frame, a trigger frame, or beamforming feedback. In some examples, the at least one PPDU has an ELR PPDU format in accordance with the SLS stage being exclusively via the 60 GHz link.

In some examples, the SLS stage includes a first phase of the beam training sequence and a second phase of the beam training sequence. In some examples, the first phase is an initiator transmission SLS phase, and the second phase is a responder transmission SLS phase.

In some examples, the first communication device transmits the set of multiple first beam training packets via a first bandwidth in accordance with the beam training sequence being via the 60 GHz link. In some examples, the first bandwidth is smaller than a second bandwidth used for data PPDU transmissions by the first communication device.

In some examples, the first bandwidth is a smallest PPDU bandwidth usable by the first communication device.

Additionally, or alternatively, the wireless communication device 2000 may support wireless communication in accordance with examples as disclosed herein. The beam refinement component 2040 is configurable or configured to transmit, via a 60 GHz link, a first PPDU that includes a set of multiple first TRN subfields in accordance with a beam training sequence between the first communication device and a second communication device, where the set of multiple first TRN subfields is transmitted using a single first transmit beam or a set of multiple first transmit beams at the first communication device in accordance with a first beam training direction. In some examples, the beam refinement component 2040 is configurable or configured to receive, via the 60 GHz link, a second PPDU that includes a set of multiple second TRN subfields in accordance with the beam training sequence between the first communication device and the second communication device, where the set of multiple second TRN subfields is received using a single first receive beam or a set of multiple first receive beams at the first communication device in accordance with a second beam training direction.

In some examples, the first beam training direction includes at least one of a transmit beam training direction from the first communication device or a receive beam training direction at the second communication device.

In some examples, the first PPDU has a PPDU format that includes one or more LTFs with configurable lengths in accordance with the first beam training direction including the receive beam training direction at the second communication device.

In some examples, the second beam training direction includes at least one of a transmit beam training direction from the second communication device or a receive beam training direction at the first communication device.

In some examples, the second PPDU has a PPDU format that includes one or more LTFs with configurable lengths in accordance with the second beam training direction including the receive beam training direction at the first communication device.

In some examples, the first PPDU is an NDP PPDU (which may be an example of a beam training packet).

In some examples, the first PPDU includes, prior to the set of multiple first TRN subfields, a first STF, a first LTF, a U-SIG, an IMMW-SIG field, a second STF, and one or more second LTFs.

In some examples, the IMMW-SIG field indicates a first set of beam training parameters according to which the set of multiple first TRN subfields is transmitted.

In some examples, the beam training setup component 2025 is configurable or configured to communicate, via a sub-7 GHz link, one or more frames that indicate a first set of beam training parameters or a first timing and frequency reference for at least the first PPDU.

In some examples, the first PPDU excludes an IMMW-SIG field in accordance with the one or more frames, communicated via the sub-7 GHz link, indicating the first set of beam training parameters.

In some examples, the first PPDU consists of the set of multiple first TRN subfields in accordance with the one or more frames, communicated via the sub-7 GHz link, indicating the first timing and frequency reference.

In some examples, the first PPDU is a data PPDU.

In some examples, the first PPDU includes, prior to the set of multiple first TRN subfields, a first STF, a first LTF, a U-SIG, an IMMW-SIG field, a second STF, one or more second LTFs, a SIG-B field, and one or more data fields.

In some examples, the IMMW-SIG field indicates one or more demodulation-related parameters according to which the second communication device is to demodulate the one or more data fields of the first PPDU.

In some examples, the SIG-B field or the IMMW-SIG field indicates a first set of beam training parameters for the set of multiple first TRN subfields.

In some examples, a first structure of the set of multiple first TRN subfields is in accordance with the first beam training direction. In some examples, a second structure of the set of multiple second TRN subfields is in accordance with the second beam training direction.

In some examples, the beam training sequence includes an SLS stage and a BRP stage. In some examples, the first PPDU and the second PPDU are exchanged within the BRP stage of the beam training sequence.

Additionally, or alternatively, the wireless communication device 2000 may support wireless communication in accordance with examples as disclosed herein. In some examples, the beam sweeping component 2030 is configurable or configured to transmit, as part of a coarse beam search stage of a two-stage beam search operation, a first set of PPDUs via a subset of a set of multiple antenna elements at the communication device, where a transmission of each PPDU of the first set of PPDUs is in accordance with an application of a respective AWV of a set of AWVs to the subset of the set of multiple antenna elements, and where each AWV of the set of AWVs corresponds to a respective coarse beam of a set of coarse beams in accordance with the application of the respective AWV to the subset of the set of multiple antenna elements. In some examples, the beam training feedback component 2035 is configurable or configured to receive feedback that indicates a first coarse beam, of the set of coarse beams, in accordance with transmitting the first set of PPDUs, where the first coarse beam corresponds to a first AWV of the set of AWVs. In some examples, the beam sweeping component 2030 is configurable or configured to transmit, as part of a fine beam search stage of the two-stage beam search operation, a second set of PPDUs via the set of multiple antenna elements at the communication device and in accordance with applying the first AWV to the subset of the set of multiple antenna elements.

In some examples, the subset of the set of multiple antenna elements excludes one or more antenna elements of the set of multiple antenna elements.

In some examples, the one or more antenna elements of the set of multiple antenna elements that are excluded from the subset of the set of multiple antenna elements includes every other antenna element of the set of multiple antenna elements.

In some examples, transmitting the second set of PPDUs is further in accordance with applying one or more other AWVs to a remainder of the set of multiple antenna elements other than the subset of the set of multiple antenna elements.

In some examples, applying each AWV of the one or more other AWVs to the remainder of the set of multiple antenna elements other than the subset of the set of multiple antenna elements forms a respective fine beam within the first coarse beam.

In some examples, the second set of PPDUs consists of a single PPDU including a set of multiple portions. In some examples, a transmission of each portion of the set of multiple portions of the single PPDU is in accordance with applying the first AWV to the subset of the set of multiple antenna elements and applying a respective other AWV to a remainder of the set of multiple antenna elements other than the subset of the set of multiple antenna elements.

In some examples, the second set of PPDUs includes a set of multiple PPDUs. In some examples, a transmission of each PPDU of the set of multiple PPDUs is in accordance with applying the first AWV to the subset of the set of multiple antenna elements, and applying a respective other AWV to a remainder of the set of multiple antenna elements other than the subset of the set of multiple antenna elements.

In some examples, the coarse beam search stage corresponds to a sector level sweep (SLS) stage. In some examples, the fine beam search stage corresponds to a beam refinement protocol (BRP) stage.

FIG. 21 shows a flowchart illustrating an example process 2100 performable by or at a first communication device that supports 60 GHz beam training designs for IMMW Wi-Fi networks. The operations of the process 2100 may be implemented by a first communication device or its components as described herein. For example, the process 2100 may be performed by a wireless communication device, such as the wireless communication device 2000 described with reference to FIG. 20, operating as or within a wireless AP or a wireless STA. In some examples, the process 2100 may be performed by a wireless AP or a wireless STA, such as one of the APs 102 or the STAs 104 described with reference to FIG. 1.

In some examples, in 2105, the first communication device may transmit, via a sub-7 GHz link, a first action frame that indicates a first set of beam training parameters and a first timing and frequency reference for at least a first phase of a beam training sequence between the first communication device and a second communication device via a 60 GHz link. In some implementations, aspects of the operations of 2105 may be performed by a beam training setup component 2025 as described with reference to FIG. 20.

In some examples, in 2110, the first communication device may transmit, via the 60 GHz link, a set of multiple first beam training packets in accordance with the first set of beam training parameters and the first timing and frequency reference, where each first beam training packet of the set of multiple first beam training packets is transmitted using a respective first transmit beam of a set of multiple first transmit beams at the first communication device. In some implementations, aspects of the operations of 2110 may be performed by a beam sweeping component 2030 as described with reference to FIG. 20.

In some examples, in 2115, the first communication device may receive, from the second communication device and via the sub-7 GHz link or the 60 GHz link, feedback on at least one first transmit beam of the set of multiple first transmit beams. In some implementations, aspects of the operations of 2115 may be performed by a beam training feedback component 2035 as described with reference to FIG. 20.

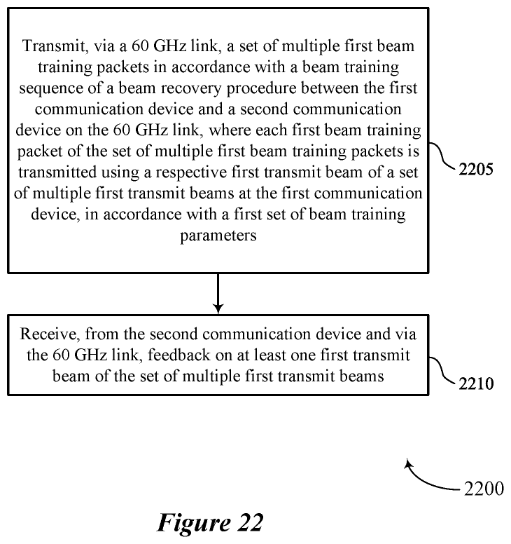

FIG. 22 shows a flowchart illustrating an example process 2200 performable by or at a first communication device that supports 60 GHz beam training designs for IMMW Wi-Fi networks. The operations of the process 2200 may be implemented by a first communication device or its components as described herein. For example, the process 2200 may be performed by a wireless communication device, such as the wireless communication device 2000 described with reference to FIG. 20, operating as or within a wireless AP or a wireless STA. In some examples, the process 2200 may be performed by a wireless AP or a wireless STA, such as one of the APs 102 or the STAs 104 described with reference to FIG. 1.

In some examples, in 2205, the first communication device may transmit, via a 60 GHz link, a set of multiple first beam training packets in accordance with a beam training sequence of a beam recovery procedure between the first communication device and a second communication device on the 60 GHz link, where each first beam training packet of the set of multiple first beam training packets is transmitted using a respective first transmit beam of a set of multiple first transmit beams at the first communication device, in accordance with a first set of beam training parameters. In some implementations, aspects of the operations of 2205 may be performed by a beam sweeping component 2030 as described with reference to FIG. 20.

In some examples, in 2210, the first communication device may receive, from the second communication device and via the 60 GHz link, feedback on at least one first transmit beam of the set of multiple first transmit beams. In some implementations, aspects of the operations of 2210 may be performed by a beam training feedback component 2035 as described with reference to FIG. 20.

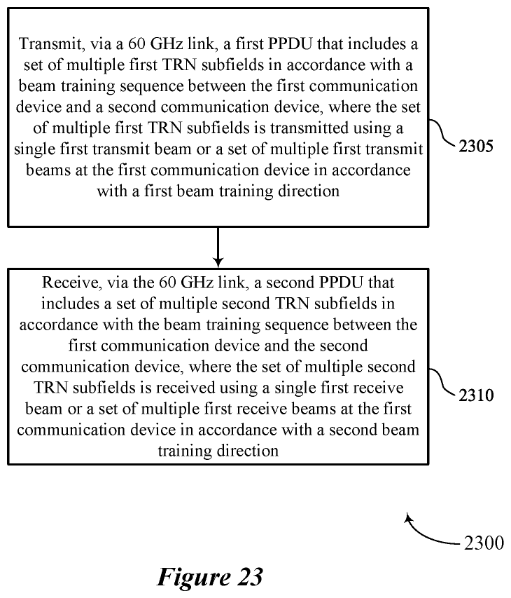

FIG. 23 shows a flowchart illustrating an example process 2300 performable by or at a first communication device that supports 60 GHz beam training designs for IMMW Wi-Fi networks. The operations of the process 2300 may be implemented by a first communication device or its components as described herein. For example, the process 2300 may be performed by a wireless communication device, such as the wireless communication device 2000 described with reference to FIG. 20, operating as or within a wireless AP or a wireless STA. In some examples, the process 2300 may be performed by a wireless AP or a wireless STA, such as one of the APs 102 or the STAs 104 described with reference to FIG. 1.

In some examples, in 2305, the first communication device may transmit, via a 60 GHz link, a first PPDU that includes a set of multiple first TRN subfields in accordance with a beam training sequence between the first communication device and a second communication device, where the set of multiple first TRN subfields is transmitted using a single first transmit beam or a set of multiple first transmit beams at the first communication device in accordance with a first beam training direction. In some implementations, aspects of the operations of 2305 may be performed by a beam refinement component 2040 as described with reference to FIG. 20.

In some examples, in 2310, the first communication device may receive, via the 60 GHz link, a second PPDU that includes a set of multiple second TRN subfields in accordance with the beam training sequence between the first communication device and the second communication device, where the set of multiple second TRN subfields is received using a single first receive beam or a set of multiple first receive beams at the first communication device in accordance with a second beam training direction. In some implementations, aspects of the operations of 2310 may be performed by a beam refinement component 2040 as described with reference to FIG. 20.

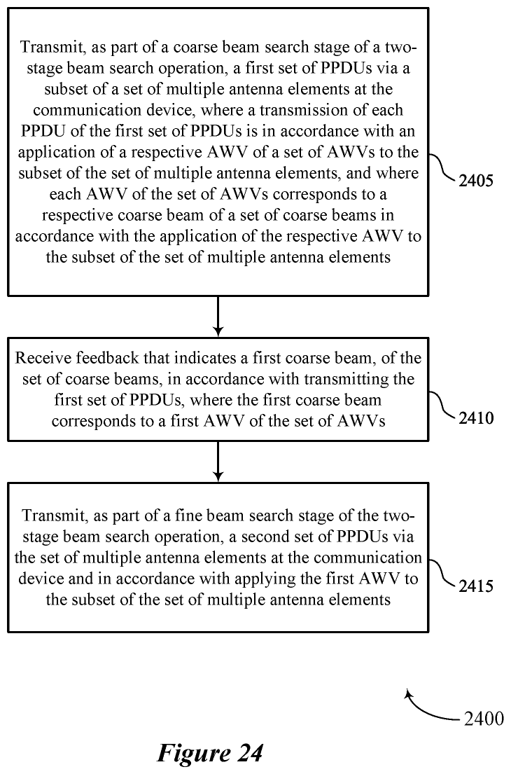

FIG. 24 shows a flowchart illustrating an example process 2400 performable by or at a communication device that supports 60 GHz beam training designs for IMMW Wi-Fi networks. The operations of the process 2400 may be implemented by a communication device or its components as described herein. For example, the process 2400 may be performed by a wireless communication device, such as the wireless communication device 2000 described with reference to FIG. 20, operating as or within a wireless AP or a wireless STA. In some examples, the process 2400 may be performed by a wireless AP or a wireless STA, such as one of the APs 102 or the STAs 104 described with reference to FIG. 1.

In some examples, in 2405, the communication device may transmit, as part of a coarse beam search stage of a two-stage beam search operation, a first set of PPDUs via a subset of a set of multiple antenna elements at the communication device, where a transmission of each PPDU of the first set of PPDUs is in accordance with an application of a respective AWV of a set of AWVs to the subset of the set of multiple antenna elements, and where each AWV of the set of AWVs corresponds to a respective coarse beam of a set of coarse beams in accordance with the application of the respective AWV to the subset of the set of multiple antenna elements. In some implementations, aspects of the operations of 2405 may be performed by a beam sweeping component 2030 as described with reference to FIG. 20.

In some examples, in 2410, the communication device may receive feedback that indicates a first coarse beam, of the set of coarse beams, in accordance with transmitting the first set of PPDUs, where the first coarse beam corresponds to a first AWV of the set of AWVs. In some implementations, aspects of the operations of 2410 may be performed by a beam training feedback component 2035 as described with reference to FIG. 20.

In some examples, in 2415, the communication device may transmit, as part of a fine beam search stage of the two-stage beam search operation, a second set of PPDUs via the set of multiple antenna elements at the communication device and in accordance with applying the first AWV to the subset of the set of multiple antenna elements. In some implementations, aspects of the operations of 2415 may be performed by a beam sweeping component 2030 as described with reference to FIG. 20.

Implementation examples are described in the following numbered clauses:
Clause 1: A method for wireless communication by a first communication device, including: transmitting, via a sub-7 GHz link, a first action frame that indicates a first set of beam training parameters and a first timing and frequency reference for at least a first phase of a beam training sequence between the first communication device and a second communication device via a 60 GHz link; transmitting, via the 60 GHz link, a set of multiple first beam training packets in accordance with the first set of beam training parameters and the first timing and frequency reference, where each first beam training packet of the set of multiple first beam training packets is transmitted using a respective first transmit beam of a set of multiple first transmit beams at the first communication device; and receiving, from the second communication device and via the sub-7 GHz link or the 60 GHz link, feedback on at least one first transmit beam of the set of multiple first transmit beams.
Clause 2: The method of clause 1, further including: monitoring the 60 GHz link for a set of multiple second beam training packets from the second communication device, where each second beam training packet of the set of multiple second beam training packets corresponds to a respective second transmit beam of a set of multiple second transmit beams at the second communication device.
Clause 3: The method of clause 2, where the set of multiple second beam training packets from the second communication device is in accordance with the first set of beam training parameters indicated by the first action frame.
Clause 4: The method of any of clauses 2-3, where at least one second beam training packet of the set of multiple second beam training packets indicates the feedback on the at least one first transmit beam of the set of multiple first transmit beams.
Clause 5: The method of clause 4, where the at least one second beam training packet indicates the feedback on the at least one first transmit beam via at least one SIG field of the at least one second beam training packet.
Clause 6: The method of any of clauses 2-5, further including: transmitting, to the second communication device and via the sub-7 GHz link, a second action frame that indicates a second set of beam training parameters and a second timing and frequency reference for a second phase of the beam training sequence between the first communication device and the second communication device, where the set of multiple second beam training packets from the second communication device is in accordance with the second set of beam training parameters and the second timing and frequency reference indicated by the second action frame.
Clause 7: The method of any of clauses 2-6, further including: receiving, from the second communication device and via the sub-7 GHz link, a second action frame that indicates second set of beam training parameters and a second timing and frequency reference for a second phase of the beam training sequence between the first communication device and the second communication device, where the set of multiple second beam training packets from the second communication device is in accordance with the second set of beam training parameters and the second timing and frequency reference indicated by the second action frame.
Clause 8: The method of any of clauses 2-7, further including: transmitting, via the sub-7 GHz link or the 60 GHz link, second feedback on at least one second transmit beam of the set of multiple second transmit beams in accordance with monitoring for the set of multiple second beam training packets from the second communication device.
Clause 9: The method of any of clauses 1-8, where transmitting the set of multiple first beam training packets includes: transmitting a set of multiple repeated versions of the set of multiple first beam training packets, where each repeated version of the set of multiple repeated versions corresponds to a respective receive beam, of a set of multiple receive beams at the second communication device, in accordance with the first set of beam training parameters.
Clause 10: The method of any of clauses 1-9, further including: monitoring the 60 GHz link for a set of multiple repeated versions of a set of multiple second beam training packets from the second communication device in accordance with using a respective receive beam, of a set of multiple receive beams at the first communication device, for each repeated version of the set of multiple repeated versions, where each second beam training packet of the set of multiple second beam training packets corresponds to a respective second transmit beam of a set of multiple second transmit beams at the second communication device.
Clause 11: The method of any of clauses 1-10, further including: transmitting, via the sub-7 GHz link, a trigger frame that solicits the feedback from the second communication device, where the feedback is received via the sub-7 GHz link in accordance with the trigger frame that solicits the feedback being transmitted via the sub-7 GHz link.
Clause 12: The method of any of clauses 1-11, where the beam training sequence includes an SLS stage and a BRP stage, and the SLS stage includes an exchange of a respective set of multiple beam training packets between the first communication device and the second communication device.
Clause 13: The method of clause 12, where the SLS stage includes the first phase of the beam training sequence and a second phase of the beam training sequence, and the first phase is an initiator transmission SLS phase, and the second phase is a responder transmission SLS phase.
Clause 14: The method of any of clauses 1-13, where each first beam training packet of the set of multiple first beam training packets excludes an IMMW-SIG field in accordance with the first action frame, transmitted via the sub-7 GHz link, indicating the first set of beam training parameters.
Clause 15: The method of any of clauses 1-14, where each first beam training packet of the set of multiple first beam training packets consists of a single LTF symbol or consists of a single LTF symbol and a single SIG field symbol in accordance with the first action frame, transmitted via the sub-7 GHz link, indicating the first timing and frequency reference.
Clause 16: The method of any of clauses 1-15, where the first communication device transmits the set of multiple first beam training packets via a first bandwidth in accordance with the beam training sequence being via the 60 GHz link, the first bandwidth is smaller than a second bandwidth used for data PPDU transmissions by the first communication device.
Clause 17: The method of clause 16, where the first bandwidth is a smallest PPDU bandwidth usable by the first communication device.
Clause 18: A method for wireless communication by a first communication device, including: transmitting, via a 60 GHz link, a set of multiple first beam training packets in accordance with a beam training sequence of a beam recovery procedure between the first communication device and a second communication device on the 60 GHz link, where each first beam training packet of the set of multiple first beam training packets is transmitted using a respective first transmit beam of a set of multiple first transmit beams at the first communication device, in accordance with a first set of beam training parameters; and receiving, from the second communication device and via the 60 GHz link, feedback on at least one first transmit beam of the set of multiple first transmit beams.
Clause 19: The method of clause 18, further including: monitoring the 60 GHz link for a set of multiple second beam training packets from the second communication device, where each second beam training packet of the set of multiple second beam training packets corresponds to a respective second transmit beam of a set of multiple second transmit beams at the second communication device.
Clause 20: The method of clause 19, where the set of multiple second beam training packets from the second communication device is in accordance with the first set of beam training parameters.
Clause 21: The method of any of clauses 19-20, where at least one second beam training packet of the set of multiple second beam training packets indicates the feedback on the at least one first transmit beam of the set of multiple first transmit beams.
Clause 22: The method of clause 21, where the at least one second beam training packet indicates the feedback on the at least one first transmit beam via at least one SIG field of the at least one second beam training packet.
Clause 23: The method of any of clauses 19-22, further including: transmitting, via the 60 GHz link, second feedback on at least one second transmit beam of the set of multiple second transmit beams in accordance with monitoring for the set of multiple second beam training packets from the second communication device.
Clause 24: The method of any of clauses 19-23, further including: receiving, from the second communication device and via the 60 GHz link, an action frame that indicates second set of beam training parameters, where reception of the set of multiple second beam training packets is in accordance with the action frame, and where the set of multiple second beam training packets from the second communication device is in accordance with the second set of beam training parameters indicated by the action frame.
Clause 25: The method of any of clauses 18-24, where transmitting the set of multiple first beam training packets includes: transmitting a set of multiple repeated versions of the set of multiple first beam training packets, where each repeated version of the set of multiple repeated versions corresponds to a respective receive beam, of a set of multiple receive beams at the second communication device, in accordance with the first set of beam training parameters.
Clause 26: The method of any of clauses 18-25, further including: monitoring the 60 GHz link for a set of multiple repeated versions of a set of multiple second beam training packets from the second communication device in accordance with using a respective receive beam, of a set of multiple receive beams at the first communication device, for each repeated version of the set of multiple repeated versions, where each second beam training packet of the set of multiple second beam training packets corresponds to a respective second transmit beam of a set of multiple second transmit beams at the second communication device.
Clause 27: The method of any of clauses 18-26, further including: transmitting, via the 60 GHz link, a trigger frame that solicits the feedback from the second communication device, where the feedback is received in accordance with the trigger frame soliciting the feedback.
Clause 28: The method of any of clauses 18-27, further including: transmitting, via the 60 GHz link, an action frame that indicates the first set of beam training parameters, where transmission of the set of multiple first beam training packets is in accordance with the action frame.
Clause 29: The method of any of clauses 18-28, where each first beam training packet of the set of multiple first beam training packets includes an IMMW-SIG field that indicates a respective subset of the first set of beam training parameters according to which that first beam training packet is transmitted.
Clause 30: The method of any of clauses 18-29, where the beam training sequence includes an SLS stage and a BRP stage, and the SLS stage includes an exchange of a respective set of multiple beam training packets between the first communication device and the second communication device exclusively via the 60 GHz link in accordance with the beam recovery procedure on the 60 GHz link.
Clause 31: The method of clause 30, where the SLS stage includes at least one PPDU that includes an action frame, a trigger frame, or beamforming feedback, and the at least one PPDU has an ELR PPDU format in accordance with the SLS stage being exclusively via the 60 GHz link.
Clause 32: The method of any of clauses 30-31, where the SLS stage includes a first phase of the beam training sequence and a second phase of the beam training sequence, and the first phase is an initiator transmission SLS phase, and the second phase is a responder transmission SLS phase.
Clause 33: The method of any of clauses 18-32, where the first communication device transmits the set of multiple first beam training packets via a first bandwidth in accordance with the beam training sequence being via the 60 GHz link, the first bandwidth is smaller than a second bandwidth used for data PPDU transmissions by the first communication device.
Clause 34: The method of clause 33, where the first bandwidth is a smallest PPDU bandwidth usable by the first communication device.
Clause 35: A method for wireless communication by a first communication device, including: transmitting, via a 60 GHz link, a first physical layer protocol data unit (PPDU) that includes a set of multiple first TRN subfields in accordance with a beam training sequence between the first communication device and a second communication device, where the set of multiple first TRN subfields is transmitted using a single first transmit beam or a set of multiple first transmit beams at the first communication device in accordance with a first beam training direction; and receiving, via the 60 GHz link, a second PPDU that includes a set of multiple second TRN subfields in accordance with the beam training sequence between the first communication device and the second communication device, where the set of multiple second TRN subfields is received using a single first receive beam or a set of multiple first receive beams at the first communication device in accordance with a second beam training direction.
Clause 36: The method of clause 35, where the first beam training direction includes at least one of a transmit beam training direction from the first communication device or a receive beam training direction at the second communication device.
Clause 37: The method of clause 36, where the first PPDU has a PPDU format that includes one or more LTFs with configurable lengths in accordance with the first beam training direction including the receive beam training direction at the second communication device.
Clause 38: The method of any of clauses 35-37, where the second beam training direction includes at least one of a transmit beam training direction from the second communication device or a receive beam training direction at the first communication device.
Clause 39: The method of clause 38, where the second PPDU has a PPDU format that includes one or more LTFs with configurable lengths in accordance with the second beam training direction including the receive beam training direction at the first communication device.
Clause 40: The method of any of clauses 35-39, where the first PPDU is a NDP PPDU.
Clause 41: The method of clause 40, where the first PPDU includes, prior to the set of multiple first TRN subfields, a first STF, a first LTF, a U-SIG field, an IMMW-SIG field, a second STF, and one or more second LTFs.
Clause 42: The method of clause 41, where the IMMW-SIG field indicates a first set of beam training parameters according to which the set of multiple first TRN subfields is transmitted.
Clause 43: The method of any of clauses 40-42, further including: communicating, via a sub-7 GHz link, one or more frames that indicate a first set of beam training parameters or a first timing and frequency reference for at least the first PPDU.
Clause 44: The method of clause 43, where the first PPDU excludes an IMMW-SIG field in accordance with the one or more frames, communicated via the sub-7 GHz link, indicating the first set of beam training parameters.
Clause 45: The method of any of clauses 43-44, where the first PPDU consists of the set of multiple first TRN subfields in accordance with the one or more frames, communicated via the sub-7 GHz link, indicating the first timing and frequency reference.
Clause 46: The method of any of clauses 35-45, where the first PPDU is a data PPDU.
Clause 47: The method of clause 46, where the first PPDU includes, prior to the set of multiple first TRN subfields, a first STF, a first LTF, a U-SIG field, an IMMW-SIG field, a second STF, one or more second LTFs, a SIG-B field, and one or more data fields.
Clause 48: The method of clause 47, where the IMMW-SIG field indicates one or more demodulation-related parameters according to which the second communication device is to demodulate the one or more data fields of the first PPDU.
Clause 49: The method of any of clauses 47-48, where the SIG-B field or the IMMW-SIG field indicates a first set of beam training parameters for the set of multiple first TRN subfields.
Clause 50: The method of any of clauses 35-49, where a first structure of the set of multiple first TRN subfields is in accordance with the first beam training direction, and a second structure of the set of multiple second TRN subfields is in accordance with the second beam training direction.
Clause 51: The method of any of clauses 35-50, where the beam training sequence includes an SLS stage and a BRP stage, and the first PPDU and the second PPDU are exchanged within the BRP stage of the beam training sequence.
Clause 52: A method for wireless communication by a communication device, including: transmitting, as part of a coarse beam search stage of a two-stage beam search operation, a first set of PPDUs via a subset of a set of multiple antenna elements at the communication device, where a transmission of each PPDU of the first set of PPDUs is in accordance with an application of a respective AWV of a set of AWVs to the subset of the set of multiple antenna elements, and where each AWV of the set of AWVs corresponds to a respective coarse beam of a set of coarse beams in accordance with the application of the respective AWV to the subset of the set of multiple antenna elements; receiving feedback that indicates a first coarse beam, of the set of coarse beams, in accordance with transmitting the first set of PPDUs, where the first coarse beam corresponds to a first AWV of the set of AWVs; and transmitting, as part of a fine beam search stage of the two-stage beam search operation, a second set of PPDUs via the set of multiple antenna elements at the communication device and in accordance with applying the first AWV to the subset of the set of multiple antenna elements.
Clause 53: The method of clause 52, where the subset of the set of multiple antenna elements excludes one or more antenna elements of the set of multiple antenna elements.
Clause 54: The method of clause 53, where the one or more antenna elements of the set of multiple antenna elements that are excluded from the subset of the set of multiple antenna elements includes every other antenna element of the set of multiple antenna elements.
Clause 55: The method of any of clauses 52-54, where transmitting the second set of PPDUs is further in accordance with applying one or more other AWVs to a remainder of the set of multiple antenna elements other than the subset of the set of multiple antenna elements.
Clause 56: The method of clause 55, where applying each AWV of the one or more other AWVs to the remainder of the set of multiple antenna elements other than the subset of the set of multiple antenna elements forms a respective fine beam within the first coarse beam.
Clause 57: The method of any of clauses 52-56, where the second set of PPDUs consists of a single PPDU including a set of multiple portions, and a transmission of each portion of the set of multiple portions of the single PPDU is in accordance with applying the first AWV to the subset of the set of multiple antenna elements and applying a respective other AWV to a remainder of the set of multiple antenna elements other than the subset of the set of multiple antenna elements.
Clause 58: The method of any of clauses 52-57, where the second set of PPDUs includes a set of multiple PPDUs, and a transmission of each PPDU of the set of multiple PPDUs is in accordance with applying the first AWV to the subset of the set of multiple antenna elements, and applying a respective other AWV to a remainder of the set of multiple antenna elements other than the subset of the set of multiple antenna elements.
Clause 59: The method of any of clauses 52-58, where the coarse beam search stage corresponds to an SLS stage, and the fine beam search stage corresponds to a BRP stage.
Clause 60: A first communication device, including: a processing system that includes processor circuitry and memory circuitry that stores code, the processing system configured to cause the first communication device to: transmit, via a sub-7 GHz link, a first action frame that indicates a first set of beam training parameters and a first timing and frequency reference for at least a first phase of a beam training sequence between the first communication device and a second communication device via a 60 GHz link; transmit, via the 60 GHz link, a set of multiple first beam training packets in accordance with the first set of beam training parameters and the first timing and frequency reference, where each first beam training packet of the set of multiple first beam training packets is transmitted using a respective first transmit beam of a set of multiple first transmit beams at the first communication device; and receive, from the second communication device and via the sub- 7 GHz link or the 60 GHz link, feedback on at least one first transmit beam of the set of multiple first transmit beams.
Clause 61: The first communication device of clause 60, where the processing system is further configured to cause the first communication device to: monitor the 60 GHz link for a set of multiple second beam training packets from the second communication device, where each second beam training packet of the set of multiple second beam training packets corresponds to a respective second transmit beam of a set of multiple second transmit beams at the second communication device.
Clause 62: The first communication device of clause 61, where the set of multiple second beam training packets from the second communication device is in accordance with the first set of beam training parameters indicated by the first action frame.
Clause 63: The first communication device of any of clauses 61-62, where at least one second beam training packet of the set of multiple second beam training packets indicates the feedback on the at least one first transmit beam of the set of multiple first transmit beams.
Clause 64: The first communication device of clause 63, where the at least one second beam training packet indicates the feedback on the at least one first transmit beam via at least one SIG field of the at least one second beam training packet.
Clause 65: The first communication device of any of clauses 61-64, where the processing system is further configured to cause the first communication device to: transmit, to the second communication device and via the sub-7 GHz link, a second action frame that indicates a second set of beam training parameters and a second timing and frequency reference for a second phase of the beam training sequence between the first communication device and the second communication device, where the set of multiple second beam training packets from the second communication device is in accordance with the second set of beam training parameters and the second timing and frequency reference indicated by the second action frame.
Clause 66: The first communication device of any of clauses 61-65, where the processing system is further configured to cause the first communication device to: receive, from the second communication device and via the sub-7 GHz link, a second action frame that indicates second set of beam training parameters and a second timing and frequency reference for a second phase of the beam training sequence between the first communication device and the second communication device, where the set of multiple second beam training packets from the second communication device is in accordance with the second set of beam training parameters and the second timing and frequency reference indicated by the second action frame.
Clause 67: The first communication device of any of clauses 61-66, where the processing system is further configured to cause the first communication device to: transmit, via the sub-7 GHz link or the 60 GHz link, second feedback on at least one second transmit beam of the set of multiple second transmit beams in accordance with monitoring for the set of multiple second beam training packets from the second communication device.
Clause 68: The first communication device of any of clauses 60-67, where, to transmit the set of multiple first beam training packets, the processing system is configured to cause the first communication device to: transmit a set of multiple repeated versions of the set of multiple first beam training packets, where each repeated version of the set of multiple repeated versions corresponds to a respective receive beam, of a set of multiple receive beams at the second communication device, in accordance with the first set of beam training parameters.
Clause 69: The first communication device of any of clauses 60-68, where the processing system is further configured to cause the first communication device to: monitor the 60 GHz link for a set of multiple repeated versions of a set of multiple second beam training packets from the second communication device in accordance with using a respective receive beam, of a set of multiple receive beams at the first communication device, for each repeated version of the set of multiple repeated versions, where each second beam training packet of the set of multiple second beam training packets corresponds to a respective second transmit beam of a set of multiple second transmit beams at the second communication device.
Clause 70: The first communication device of any of clauses 60-69, where the processing system is further configured to cause the first communication device to: transmit, via the sub-7 GHz link, a trigger frame that solicits the feedback from the second communication device, where the feedback is received via the sub-7 GHz link in accordance with the trigger frame that solicits the feedback being transmitted via the sub-7 GHz link.
Clause 71: The first communication device of any of clauses 60-70, where the beam training sequence includes an SLS stage and a BRP stage, and the SLS stage includes an exchange of a respective set of multiple beam training packets between the first communication device and the second communication device.
Clause 72: The first communication device of clause 71, where the SLS stage includes the first phase of the beam training sequence and a second phase of the beam training sequence, and the first phase is an initiator transmission SLS phase, and the second phase is a responder transmission SLS phase.
Clause 73: The first communication device of any of clauses 60-72, where each first beam training packet of the set of multiple first beam training packets excludes an IMMW-SIG field in accordance with the first action frame, transmitted via the sub-7 GHz link, indicating the first set of beam training parameters.
Clause 74: The first communication device of any of clauses 60-73, where each first beam training packet of the set of multiple first beam training packets consists of a single LTF symbol or consists of a single LTF symbol and a single SIG field symbol in accordance with the first action frame, transmitted via the sub-7 GHz link, indicating the first timing and frequency reference.
Clause 75: The first communication device of any of clauses 60-74, where the first communication device transmits the set of multiple first beam training packets via a first bandwidth in accordance with the beam training sequence being via the 60 GHz link, the first bandwidth is smaller than a second bandwidth used for data PPDU transmissions by the first communication device.
Clause 76: The first communication device of clause 75, where the first bandwidth is a smallest PPDU bandwidth usable by the first communication device.
Clause 77: A first communication device, including: a processing system that includes processor circuitry and memory circuitry that stores code, the processing system configured to cause the first communication device to: transmit, via a 60 GHz link, a set of multiple first beam training packets in accordance with a beam training sequence of a beam recovery procedure between the first communication device and a second communication device on the 60 GHz link, where each first beam training packet of the set of multiple first beam training packets is transmitted using a respective first transmit beam of a set of multiple first transmit beams at the first communication device, in accordance with a first set of beam training parameters; and receive, from the second communication device and via the 60 GHz link, feedback on at least one first transmit beam of the set of multiple first transmit beams.
Clause 78: The first communication device of clause 77, where the processing system is further configured to cause the first communication device to: monitor the 60 GHz link for a set of multiple second beam training packets from the second communication device, where each second beam training packet of the set of multiple second beam training packets corresponds to a respective second transmit beam of a set of multiple second transmit beams at the second communication device.
Clause 79: The first communication device of clause 78, where the set of multiple second beam training packets from the second communication device is in accordance with the first set of beam training parameters.
Clause 80: The first communication device of any of clauses 78-79, where at least one second beam training packet of the set of multiple second beam training packets indicates the feedback on the at least one first transmit beam of the set of multiple first transmit beams.
Clause 81: The first communication device of clause 80, where the at least one second beam training packet indicates the feedback on the at least one first transmit beam via at least one SIG field of the at least one second beam training packet.
Clause 82: The first communication device of any of clauses 78-81, where the processing system is further configured to cause the first communication device to: transmit, via the 60 GHz link, second feedback on at least one second transmit beam of the set of multiple second transmit beams in accordance with monitoring for the set of multiple second beam training packets from the second communication device.
Clause 83: The first communication device of any of clauses 78-82, where the processing system is further configured to cause the first communication device to: receive, from the second communication device and via the 60 GHz link, an action frame that indicates second set of beam training parameters, where reception of the set of multiple second beam training packets is in accordance with the action frame, and where the set of multiple second beam training packets from the second communication device is in accordance with the second set of beam training parameters indicated by the action frame.
Clause 84: The first communication device of any of clauses 77-83, where, to transmit the set of multiple first beam training packets, the processing system is configured to cause the first communication device to: transmit a set of multiple repeated versions of the set of multiple first beam training packets, where each repeated version of the set of multiple repeated versions corresponds to a respective receive beam, of a set of multiple receive beams at the second communication device, in accordance with the first set of beam training parameters.
Clause 85: The first communication device of any of clauses 77-84, where the processing system is further configured to cause the first communication device to: monitor the 60 GHz link for a set of multiple repeated versions of a set of multiple second beam training packets from the second communication device in accordance with using a respective receive beam, of a set of multiple receive beams at the first communication device, for each repeated version of the set of multiple repeated versions, where each second beam training packet of the set of multiple second beam training packets corresponds to a respective second transmit beam of a set of multiple second transmit beams at the second communication device.
Clause 86: The first communication device of any of clauses 77-85, where the processing system is further configured to cause the first communication device to: transmit, via the 60 GHz link, a trigger frame that solicits the feedback from the second communication device, where the feedback is received in accordance with the trigger frame soliciting the feedback.
Clause 87: The first communication device of any of clauses 77-86, where the processing system is further configured to cause the first communication device to: transmit, via the 60 GHz link, an action frame that indicates the first set of beam training parameters, where transmission of the set of multiple first beam training packets is in accordance with the action frame.
Clause 88: The first communication device of any of clauses 77-87, where each first beam training packet of the set of multiple first beam training packets includes an IMMW-SIG field that indicates a respective subset of the first set of beam training parameters according to which that first beam training packet is transmitted.
Clause 89: The first communication device of any of clauses 77-88, where the beam training sequence includes an SLS stage and a BRP stage, and the SLS stage includes an exchange of a respective set of multiple beam training packets between the first communication device and the second communication device exclusively via the 60 GHz link in accordance with the beam recovery procedure on the 60 GHz link.
Clause 90: The first communication device of clause 89, where the SLS stage includes at least one PPDU that includes an action frame, a trigger frame, or beamforming feedback, and the at least one PPDU has an ELR PPDU format in accordance with the SLS stage being exclusively via the 60 GHz link.
Clause 91: The first communication device of any of clauses 89-90, where the SLS stage includes a first phase of the beam training sequence and a second phase of the beam training sequence, and the first phase is an initiator transmission SLS phase, and the second phase is a responder transmission SLS phase.
Clause 92: The first communication device of any of clauses 77-91, where the first communication device transmits the set of multiple first beam training packets via a first bandwidth in accordance with the beam training sequence being via the 60 GHz link, the first bandwidth is smaller than a second bandwidth used for data PPDU transmissions by the first communication device.
Clause 93: The first communication device of clause 92, where the first bandwidth is a smallest PPDU bandwidth usable by the first communication device.
Clause 94: A first communication device, including: a processing system that includes processor circuitry and memory circuitry that stores code, the processing system configured to cause the first communication device to: transmit, via a 60 GHz link, a first physical layer protocol data unit (PPDU) that includes a set of multiple first TRN subfields in accordance with a beam training sequence between the first communication device and a second communication device, where the set of multiple first TRN subfields is transmitted using a single first transmit beam or a set of multiple first transmit beams at the first communication device in accordance with a first beam training direction; and receive, via the 60 GHz link, a second PPDU that includes a set of multiple second TRN subfields in accordance with the beam training sequence between the first communication device and the second communication device, where the set of multiple second TRN subfields is received using a single first receive beam or a set of multiple first receive beams at the first communication device in accordance with a second beam training direction.
Clause 95: The first communication device of clause 94, where the first beam training direction includes at least one of a transmit beam training direction from the first communication device or a receive beam training direction at the second communication device.
Clause 96: The first communication device of clause 95, where the first PPDU has a PPDU format that includes one or more LTFs with configurable lengths in accordance with the first beam training direction including the receive beam training direction at the second communication device.
Clause 97: The first communication device of any of clauses 94-96, where the second beam training direction includes at least one of a transmit beam training direction from the second communication device or a receive beam training direction at the first communication device.
Clause 98: The first communication device of clause 97, where the second PPDU has a PPDU format that includes one or more LTFs with configurable lengths in accordance with the second beam training direction including the receive beam training direction at the first communication device.
Clause 99: The first communication device of any of clauses 94-98, where the first PPDU is a NDP PPDU.
Clause 100: The first communication device of clause 99, where: the first PPDU includes, prior to the set of multiple first TRN subfields, a first STF, a first LTF, a U-SIG field, an IMMW-SIG field, a second STF, and one or more second LTFs.
Clause 101: The first communication device of clause 100, where the IMMW-SIG field indicates a first set of beam training parameters according to which the set of multiple first TRN subfields is transmitted.
Clause 102: The first communication device of any of clauses 99-101, where the processing system is further configured to cause the first communication device to: communicate, via a sub-7 GHz link, one or more frames that indicate a first set of beam training parameters or a first timing and frequency reference for at least the first PPDU.
Clause 103: The first communication device of clause 102, where the first PPDU excludes an IMMW-SIG field in accordance with the one or more frames, communicated via the sub-7 GHz link, indicating the first set of beam training parameters.
Clause 104: The first communication device of any of clauses 102-103, where the first PPDU consists of the set of multiple first TRN subfields in accordance with the one or more frames, communicated via the sub-7 GHz link, indicating the first timing and frequency reference.
Clause 105: The first communication device of any of clauses 94-104, where the first PPDU is a data PPDU.
Clause 106: The first communication device of clause 105, where: the first PPDU includes, prior to the set of multiple first TRN subfields, a first STF, a first LTF, a U-SIG field, an IMMW-SIG field, a second STF, one or more second LTFs, a SIG-B field, and one or more data fields.
Clause 107: The first communication device of clause 106, where the IMMW-SIG field indicates one or more demodulation-related parameters according to which the second communication device is to demodulate the one or more data fields of the first PPDU.
Clause 108: The first communication device of any of clauses 106-107, where the SIG-B field or the IMMW-SIG field indicates a first set of beam training parameters for the set of multiple first TRN subfields.
Clause 109: The first communication device of any of clauses 94-108, where a first structure of the set of multiple first TRN subfields is in accordance with the first beam training direction, and a second structure of the set of multiple second TRN subfields is in accordance with the second beam training direction.
Clause 110: The first communication device of any of clauses 94-109, where the beam training sequence includes an SLS stage and a BRP stage, and the first PPDU and the second PPDU are exchanged within the BRP stage of the beam training sequence.
Clause 111: A communication device, including: a processing system that includes processor circuitry and memory circuitry that stores code, the processing system configured to cause the communication device to: transmit, as part of a coarse beam search stage of a two-stage beam search operation, a first set of PPDUs via a subset of a set of multiple antenna elements at the communication device, where a transmission of each PPDU of the first set of PPDUs is in accordance with an application of a respective AWV of a set of AWVs to the subset of the set of multiple antenna elements, and where each AWV of the set of AWVs corresponds to a respective coarse beam of a set of coarse beams in accordance with the application of the respective AWV to the subset of the set of multiple antenna elements; receive feedback that indicates a first coarse beam, of the set of coarse beams, in accordance with transmitting the first set of PPDUs, where the first coarse beam corresponds to a first AWV of the set of AWVs; and transmit, as part of a fine beam search stage of the two-stage beam search operation, a second set of PPDUs via the set of multiple antenna elements at the communication device and in accordance with applying the first AWV to the subset of the set of multiple antenna elements.
Clause 112: The communication device of clause 111, where the subset of the set of multiple antenna elements excludes one or more antenna elements of the set of multiple antenna elements.
Clause 113: The communication device of clause 112, where the one or more antenna elements of the set of multiple antenna elements that are excluded from the subset of the set of multiple antenna elements includes every other antenna element of the set of multiple antenna elements.
Clause 114: The communication device of any of clauses 111-113, where transmitting the second set of PPDUs is further in accordance with applying one or more other AWVs to a remainder of the set of multiple antenna elements other than the subset of the set of multiple antenna elements.
Clause 115: The communication device of clause 114, where applying each AWV of the one or more other AWVs to the remainder of the set of multiple antenna elements other than the subset of the set of multiple antenna elements forms a respective fine beam within the first coarse beam.
Clause 116: The communication device of any of clauses 111-115, where the second set of PPDUs consists of a single PPDU including a set of multiple portions, and a transmission of each portion of the set of multiple portions of the single PPDU is in accordance with applying the first AWV to the subset of the set of multiple antenna elements and applying a respective other AWV to a remainder of the set of multiple antenna elements other than the subset of the set of multiple antenna elements.
Clause 117: The communication device of any of clauses 111-116, where the second set of PPDUs includes a set of multiple PPDUs, and a transmission of each PPDU of the set of multiple PPDUs is in accordance with applying the first AWV to the subset of the set of multiple antenna elements, and applying a respective other AWV to a remainder of the set of multiple antenna elements other than the subset of the set of multiple antenna elements.
Clause 118: The communication device of any of clauses 111-117, where the coarse beam search stage corresponds to an SLS stage, and the fine beam search stage corresponds to a BRP stage.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information) or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first communication device, comprising:
a processing system that includes processor circuitry and memory circuitry that stores code, the processing system configured to cause the first communication device to:
transmit, via a sub-7 gigahertz (GHz) link, a first action frame that indicates a first set of beam training parameters and a first timing and frequency reference for at least a first phase of a beam training sequence between the first communication device and a second communication device via a 60 GHz link;
transmit, via the 60 GHz link, a plurality of first beam training packets in accordance with the first set of beam training parameters and the first timing and frequency reference, wherein each first beam training packet of the plurality of first beam training packets is transmitted using a respective first transmit beam of a plurality of first transmit beams at the first communication device; and
receive, from the second communication device and via the sub-7 GHz link or the 60 GHz link, feedback on at least one first transmit beam of the plurality of first transmit beams.

2. The first communication device of claim 1, wherein the processing system is further configured to cause the first communication device to:
monitor the 60 GHz link for a plurality of second beam training packets from the second communication device, wherein each second beam training packet of the plurality of second beam training packets corresponds to a respective second transmit beam of a plurality of second transmit beams at the second communication device.

3. The first communication device of claim 2, wherein the plurality of second beam training packets from the second communication device is in accordance with the first set of beam training parameters indicated by the first action frame.

4. The first communication device of claim 2, wherein at least one second beam training packet of the plurality of second beam training packets indicates the feedback on the at least one first transmit beam of the plurality of first transmit beams.

5. The first communication device of claim 2, wherein the processing system is further configured to cause the first communication device to:
transmit, to the second communication device and via the sub-7 GHz link, a second action frame that indicates a second set of beam training parameters and a second timing and frequency reference for a second phase of the beam training sequence between the first communication device and the second communication device, wherein the plurality of second beam training packets from the second communication device is in accordance with the second set of beam training parameters and the second timing and frequency reference indicated by the second action frame.

6. The first communication device of claim 2, wherein the processing system is further configured to cause the first communication device to:
receive, from the second communication device and via the sub-7 GHz link, a second action frame that indicates second set of beam training parameters and a second timing and frequency reference for a second phase of the beam training sequence between the first communication device and the second communication device, wherein the plurality of second beam training packets from the second communication device is in accordance with the second set of beam training parameters and the second timing and frequency reference indicated by the second action frame.

7. The first communication device of claim 2, wherein the processing system is further configured to cause the first communication device to:
transmit, via the sub-7 GHz link or the 60 GHz link, second feedback on at least one second transmit beam of the plurality of second transmit beams in accordance with monitoring for the plurality of second beam training packets from the second communication device.

8. The first communication device of claim 1, wherein, to transmit the plurality of first beam training packets, the processing system is configured to cause the first communication device to:
transmit a plurality of repeated versions of the plurality of first beam training packets, wherein each repeated version of the plurality of repeated versions corresponds to a respective receive beam, of a plurality of receive beams at the second communication device, in accordance with the first set of beam training parameters.

9. The first communication device of claim 1, wherein the processing system is further configured to cause the first communication device to:
monitor the 60 GHz link for a plurality of repeated versions of a plurality of second beam training packets from the second communication device in accordance with using a respective receive beam, of a plurality of receive beams at the first communication device, for each repeated version of the plurality of repeated versions, wherein each second beam training packet of the plurality of second beam training packets corresponds to a respective second transmit beam of a plurality of second transmit beams at the second communication device.

10. The first communication device of claim 1, wherein the processing system is further configured to cause the first communication device to:
transmit, via the sub-7 GHz link, a trigger frame that solicits the feedback from the second communication device, wherein the feedback is received via the sub-7 GHz link in accordance with the trigger frame that solicits the feedback being transmitted via the sub-7 GHz link.

11. A first communication device, comprising:
a processing system that includes processor circuitry and memory circuitry that stores code, the processing system configured to cause the first communication device to:
transmit, via a 60 gigahertz (GHz) link, a plurality of first beam training packets in accordance with a beam training sequence of a beam recovery procedure between the first communication device and a second communication device on the 60 GHz link, wherein each first beam training packet of the plurality of first beam training packets is transmitted using a respective first transmit beam of a plurality of first transmit beams at the first communication device, in accordance with a first set of beam training parameters; and
receive, from the second communication device and via the

60. GHz link, feedback on at least one first transmit beam of the plurality of first transmit beams.

12. The first communication device of claim 11, wherein the processing system is further configured to cause the first communication device to:
monitor the 60 GHz link for a plurality of second beam training packets from the second communication device, wherein each second beam training packet of the plurality of second beam training packets corresponds to a respective second transmit beam of a plurality of second transmit beams at the second communication device.

13. The first communication device of claim 12, wherein the plurality of second beam training packets from the second communication device is in accordance with the first set of beam training parameters.

14. The first communication device of claim 12, wherein at least one second beam training packet of the plurality of second beam training packets indicates the feedback on the at least one first transmit beam of the plurality of first transmit beams.

15. The first communication device of claim 12, wherein the processing system is further configured to cause the first communication device to:
transmit, via the 60 GHz link, second feedback on at least one second transmit beam of the plurality of second transmit beams in accordance with monitoring for the plurality of second beam training packets from the second communication device.

16. The first communication device of claim 12, wherein the processing system is further configured to cause the first communication device to:
receive, from the second communication device and via the 60 GHz link, an action frame that indicates second set of beam training parameters, wherein reception of the plurality of second beam training packets is in accordance with the action frame, and wherein the plurality of second beam training packets from the second communication device is in accordance with the second set of beam training parameters indicated by the action frame.

17. The first communication device of claim 11, wherein, to transmit the plurality of first beam training packets, the processing system is configured to cause the first communication device to:
transmit a plurality of repeated versions of the plurality of first beam training packets, wherein each repeated version of the plurality of repeated versions corresponds to a respective receive beam, of a plurality of receive beams at the second communication device, in accordance with the first set of beam training parameters.

18. The first communication device of claim 11, wherein the processing system is further configured to cause the first communication device to:
monitor the 60 GHz link for a plurality of repeated versions of a plurality of second beam training packets from the second communication device in accordance with using a respective receive beam, of a plurality of receive beams at the first communication device, for each repeated version of the plurality of repeated versions, wherein each second beam training packet of the plurality of second beam training packets corresponds to a respective second transmit beam of a plurality of second transmit beams at the second communication device.

19. The first communication device of claim 11, wherein the processing system is further configured to cause the first communication device to:
transmit, via the 60 GHz link, a trigger frame that solicits the feedback from the second communication device, wherein the feedback is received in accordance with the trigger frame soliciting the feedback.

20. The first communication device of claim 11, wherein the processing system is further configured to cause the first communication device to:
transmit, via the 60 GHz link, an action frame that indicates the first set of beam training parameters, wherein transmission of the plurality of first beam training packets is in accordance with the action frame.

21. A first communication device, comprising:
a processing system that includes processor circuitry and memory circuitry that stores code, the processing system configured to cause the first communication device to:
transmit, via a 60 gigahertz (GHz) link, a first physical layer protocol data unit (PPDU) that comprises a plurality of first training (TRN) subfields in accordance with a beam training sequence between the first communication device and a second communication device, wherein the plurality of first TRN subfields is transmitted using a single first transmit beam or a plurality of first transmit beams at the first communication device in accordance with a first beam training direction; and
receive, via the 60 GHz link, a second PPDU that comprises a plurality of second TRN subfields in accordance with the beam training sequence between the first communication device and the second communication device, wherein the plurality of second TRN subfields is received using a single first receive beam or a plurality of first receive beams at the first communication device in accordance with a second beam training direction.

22. The first communication device of claim 21, wherein the first beam training direction comprises at least one of a transmit beam training direction from the first communication device or a receive beam training direction at the second communication device.

23. The first communication device of claim 22, wherein the first PPDU has a PPDU format that comprises one or more long training fields (LTFs) with configurable lengths in accordance with the first beam training direction comprising the receive beam training direction at the second communication device.

24. The first communication device of claim 21, wherein the second beam training direction comprises at least one of a transmit beam training direction from the second communication device or a receive beam training direction at the first communication device.

25. The first communication device of claim 24, wherein the second PPDU has a PPDU format that comprises one or more long training fields (LTFs) with configurable lengths in accordance with the second beam training direction comprising the receive beam training direction at the first communication device.

26. A communication device, comprising:
a processing system that includes processor circuitry and memory circuitry that stores code, the processing system configured to cause the communication device to:
transmit, as part of a coarse beam search stage of a two-stage beam search operation, a first set of physical layer protocol data units (PPDUs) via a subset of a plurality of antenna elements at the communication device, wherein a transmission of each PPDU of the first set of PPDUs is in accordance with an application of a respective antenna weight vector (AWV) of a set of AWVs to the subset of the plurality of antenna elements, and wherein each AWV of the set of AWVs corresponds to a respective coarse beam of a set of coarse beams in accordance with the application of the respective AWV to the subset of the plurality of antenna elements;
receive feedback that indicates a first coarse beam, of the set of coarse beams, in accordance with transmitting the first set of PPDUs, wherein the first coarse beam corresponds to a first AWV of the set of AWVs; and
transmit, as part of a fine beam search stage of the two-stage beam search operation, a second set of PPDUs via the plurality of antenna elements at the communication device and in accordance with applying the first AWV to the subset of the plurality of antenna elements.

27. The communication device of claim 26, wherein the subset of the plurality of antenna elements excludes one or more antenna elements of the plurality of antenna elements.

28. The communication device of claim 26, wherein transmitting the second set of PPDUs is further in accordance with applying one or more other AWVs to a remainder of the plurality of antenna elements other than the subset of the plurality of antenna elements.

29. The communication device of claim 26, wherein:
the second set of PPDUs consists of a single PPDU comprising a plurality of portions, and
a transmission of each portion of the plurality of portions of the single PPDU is in accordance with applying the first AWV to the subset of the plurality of antenna elements and applying a respective other AWV to a remainder of the plurality of antenna elements other than the subset of the plurality of antenna elements.

30. The communication device of claim 26, wherein:
the second set of PPDUs comprises a plurality of PPDUs, and
a transmission of each PPDU of the plurality of PPDUs is in accordance with applying the first AWV to the subset of the plurality of antenna elements, and applying a respective other AWV to a remainder of the plurality of antenna elements other than the subset of the plurality of antenna elements.
